(19) United States
(12) Patent Application Publication
(10) Pub. No.: US 2026/0355696 A1
(43) Pub. Date: Nov. 12, 2026

(54) DEHYDRATION MEMBRANES, METHODS OF PREPARING MEMBRANES, AND METHODS OF SEPARATING FLUIDS

(71) Applicant: Zenith Purification, LLC, Missouri City, TX (US)

(72) Inventor: Jian J. ZOU, Sugar Land, TX (US)

(21) Appl. No.: 19/110,038

(22) PCT Filed: Sep. 8, 2023
(86) PCT No.: PCT/US2023/032245

§ 371 Date: Mar. 7, 2025

Related U.S. Application Data
(60) Provisional application No. 63/404,887, filed on Sep. 8, 2022.
(60) Provisional application No. 63/404,877, filed on Sep. 8, 2022.

(51) Int. Cl. B01D 69/10; B01D 53/22; B01D 53/26; B01D 69/02; B01D 69/06; B01D 69/08; B01D 69/14; B01D 71/02; B01D 71/38; B01D 71/60; F24F 8/10

(52) U.S. Cl. CPC B01D 69/1071; B01D 53/228; B01D 53/268; B01D 69/02; B01D 69/06; B01D 69/08; B01D 69/14111; B01D 69/148; B01D 71/022; B01D 71/024; B01D 71/381; B01D 71/60; B01D 2325/04; F24F 8/10

(57) ABSTRACT

Embodiments of the present disclosure generally relate to dehydration membranes which have one or more selective layers, methods for preparing such membranes, and methods for separating water from a fluid mixture with such membranes. The dehydration membranes are capable of permeating water selectively to a low-pressure or low-concentration permeate side at a greater transport rate than other fluid components. In one or more embodiments, a dehydration membrane is provided and includes a non-woven fabric backing, a porous support layer disposed on the non-woven fabric backing, and one or more selective layers disposed on or above the porous support layer. Each of the selective layers independently contains a selective polymeric material and at least one of the selective layers contains an ethylene vinyl alcohol polymeric material as the selective polymeric material.

### CROSS-REFERENCE TO RELATED APPLICATIONS

This application claims benefit to U.S. Prov. Appl. No. 63/404,877, filed on Sep. 8, 2022, and U.S. Prov. Appl. No. 63/404,887, filed on Sep. 8, 2022, which are herein incorporated by reference in their entirety.

### BACKGROUND

### Field

Embodiments of the present disclosure generally relate to membrane technology, and more specifically, dehydration membranes, methods for preparing such membranes, and methods for dehydrating fluids (e.g., gases and/or liquids) with such membranes.

### Description of the Related Art

The process of separating, removing, or reducing water from a fluid, such as a gas mixture or a liquid mixture, is important in our daily life as well as in the chemical, petrochemical, and energy industries. For example, moisture is removed from the air to control humidity within the environment humans live and work. The process of removing moisture from structures or vehicles is critical to provide human comfort, prevent mold growth, and ensure durability of the structure or vehicle. In other aspects, the processes of removing water from a wide range of organic solvents, chemical intermediates, and products are commonly used in chemical and petrochemical industries. In further aspects, an example of water removal is the pervaporation process by which water is selectively removed through a membrane from liquids, such as organic solvents and monomers.

The current commercial dehydration membranes, such as membranes based on cellulose acetate, have some limitations. For example, these dehydration membranes are susceptible to degradation when dehydrating organic solvents at temperatures of greater than 50 °C.

Therefore, there is a need for improved dehydration membranes and methods for preparing such membranes, and methods for dehydrating fluids with such membranes.

### SUMMARY

Embodiments of the present disclosure generally relate to dehydration membranes which have one or more selective layers, methods for preparing such membranes, and methods for separating water from a fluid mixture with such membranes. The dehydration membranes are capable of permeating water selectively to a low-pressure or low-concentration permeate side at a greater transport rate than other fluid components.

In one or more embodiments, a dehydration membrane is provided and includes a non-woven fabric backing, a porous support layer disposed on the non-woven fabric backing, and one or more selective layers disposed on or above the porous support layer. Each of the selective layers independently contains a selective polymeric material and at least one of the selective layers contains an ethylene vinyl alcohol polymeric material as the selective polymeric material.

In some embodiments, a dehydration membrane is provided and includes a non-woven fabric backing, a porous support layer disposed on the non-woven fabric backing, a first selective layer disposed on the porous support layer and containing a first selective polymeric material, and a second selective layer disposed on the first selective layer. The second selective layer contains a second selective polymeric material. The first selective polymeric material, the second selective polymeric material, or both the first and second selective polymeric materials contains an ethylene vinyl alcohol polymeric material.

In other embodiments, a dehydration membrane is provided and includes a porous support layer and one or more selective layers disposed on or above the porous support layer. Each of the selective layers independently contains a selective polymeric material and at least one of the selective layers contains an ethylene vinyl alcohol polymeric material as the selective polymeric material.

In some embodiments, a dehydration membrane is provided and includes a porous support layer, a first selective layer disposed on the porous support layer and containing a first selective polymeric material, and a second selective layer disposed on the first selective layer, and the second selective layer contains a second selective polymeric material. The first selective polymeric material, the second selective polymeric material, or both the first and second selective polymeric materials contains an ethylene vinyl alcohol polymeric material.

In one or more embodiments, a method for preparing one or more selective layers is provided and includes combining an ethylene vinyl alcohol copolymer, an optional polyelectrolyte, an optional cross-linking agent, an optional catalyst, optional metal nanoparticles, and a solvent to produce a selective layer material mixture, coating the selective layer material mixture to the porous support layer, and drying the selective layer material mixture to produce the selective layer disposed on the porous support layer.

In other embodiments, a method for separating water from a fluid is provided and includes introducing a fluid mixture containing water and a base fluid to a feed side of a dehydration membrane, recovering or removing the water from a permeate side of the dehydration membrane, and retaining the base fluid on the feed side. In some examples, the fluid mixture contains air, natural gas, flue gas, syngas, biogas, a refinery gas, or any combination thereof. In other examples, the fluid mixture contains crude oil, fuel, organic solvent, a hydrocarbon gas, a hydrocarbon liquid, a product stream in a chemical or petrochemical facility, or any combination thereof.

In some embodiments, a method for separating water from air is provided and includes introducing a humid air to a feed side of a dehydration membrane, recovering or removing water from a permeate side of the dehydration membrane, and retaining a dehumidified air on the feed side. In one or more examples, the method further includes introducing the dehumidified air into a heating system, a ventilation system, or an air conditioning system.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1 depicts a cross-sectional view of a flat sheet membrane, as described and discussed in one or more embodiments herein.

FIG. 2 depicts a cross-sectional view of another flat sheet membrane, as described and discussed in one or more embodiments herein.

FIG. 3 depicts a cross-sectional view of a hollow fiber membrane, as described and discussed in one or more embodiments herein.

FIG. 4 depicts a cross-sectional view of another hollow fiber membrane, as described and discussed in one or more embodiments herein.

To facilitate understanding, identical reference numerals have been used, where possible, to designate identical elements that are common to the Figures. It is contemplated that elements and features of one or more embodiments may be beneficially incorporated in other embodiments.

### DETAILED DESCRIPTION

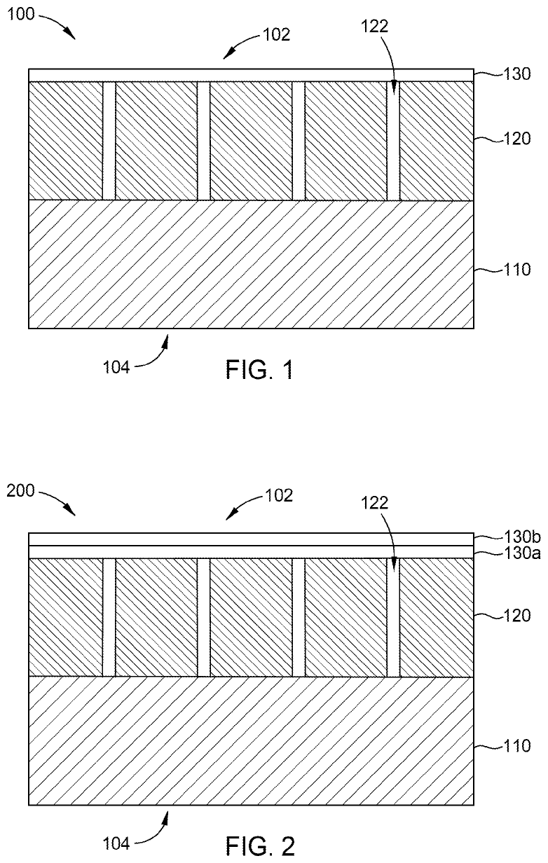

Embodiments of the present disclosure generally relate to dehydration membranes which have one or more selective layers, methods for preparing such membranes, and methods for separating water from fluids (e.g., gases and/or liquids) with such membranes. The dehydration membranes are capable of permeating water selectively to a low-pressure or low-concentration permeate side at a greater transport rate than other fluid components. FIGS. 1-4 depict cross-sectional views of dehydration membranes 100-400, respectively, as described and discussed in various embodiments herein. The dehydration membranes 100-400 are exemplary membranes and other variations of these membranes are in the scope on the present disclosure.

Each of the dehydration membranes 100-400 has a feed side 102 opposite a permeate side 104. During water separation, a fluid mixture containing water and a base fluid (e.g., gas, liquid, or a combination thereof) is introduced to the feed side 102. The water is removed from the feed side 102, passes through the dehydration membranes 100-400, and is recovered from the permeate side 104. The remaining base fluid is retained, or substantially retained at the feed side 102.

In embodiments described and discussed herein, each of the dehydration membranes 100-400 contain one, two, or more selective layers 130 which are used to selectively permeate water over other fluid components including one or more gas components and/or one or more liquid components. The selective layers, as described and discussed herein, are non-porous membranes which contain a dense selective polymeric layer without pores of greater than 10 Å. The spaces disposed between polymer chains in the non-porous membranes are 10 Å or less (e.g., about 1 Å to 10 Å) in diameter and selective water transport occurs by diffusion through these spaces.

FIG. 1 depicts a cross-sectional view of a dehydration membrane 100, such as a flat sheet membrane, as described and discussed in one or more embodiments herein. The dehydration membrane 100 contains a non-woven fabric backing 110, a porous support layer 120 containing a plurality of pores 122 and disposed on or above the non-woven fabric backing 110, and a selective layer 130 disposed on or above the porous support layer 120. As shown in FIG. 1, the dehydration membrane 100 contains the selective layer 130 disposed directly on the porous support layer 120. In other embodiments, not shown, one or more other layers can be disposed between the porous support layer 120 and the selective layer 130.

In one or more embodiments, the selective layer 130 contains one or more selective polymeric materials, such as one or more ethylene vinyl alcohol polymeric materials. As further described and discussed below, the selective layer 130 and/or the selective polymeric material can optionally contain one or more polyelectrolytes, one or more cross-linking agents, one or more functionalization agent, one or more catalysts, one or more types of metal nanoparticles, or any combination thereof.

FIG. 2 depicts a cross-sectional view of a dehydration membrane 200, such as another flat sheet membrane, as described and discussed in one or more embodiments herein. The dehydration membrane 200 contains the non-woven fabric backing 110, the porous support layer 120 containing the plurality of pores 122 and disposed on or above the non-woven fabric backing 110, a first selective layer 130a disposed on or above the porous support layer 120, and a second selective layer 130b disposed on or above the first selective layer 130a. In some embodiments, the dehydration membrane 200 contains similar layers as the dehydration membrane 100 but has two or more selective layers 130a, 130b (collectively referred to as selective layers 130).

In other embodiments, not shown in the Figures, the dehydration membranes 100, 200 (as well as dehydration membranes 300, 400) can include any number of selective layers 130. For example, any of the dehydration membranes 100-400 can include a range from 1, 2, 3, 4, or 5 selective layers 130 to about 6, 7, 8, 9, 10, 12, 15, 20, 35, 50, 80, 100, 120, 135, 150, 180, 200, or more selective layers 130. In one or more embodiments, a plurality of selective layers 130 is disposed on or over the porous support layer 120, and the plurality of selective layers 130 contains from 2 selective layers 130 to about 200 selective layers 130. In some embodiments, each of the selective layers 130 contains a different composition than the composition of an adjacent or neighboring selective layer 130.

In one or more examples, each of the selective layers 130a, 130b independently contains one or more selective polymeric materials, and at least one of the selective layers 130a, 130b contains one or more ethylene vinyl alcohol polymeric materials. In some examples, the first selective layer 130a is directly disposed on the porous support layer 120 and contains a first selective polymeric material and a second selective layer 130b is directly disposed on the first selective layer 130a. The second selective layer 130b contains a second selective polymeric material. In one or more examples, the first selective polymeric material, the second selective polymeric material, or both the first and second selective polymeric materials independently contains one or more ethylene vinyl alcohol polymeric materials.

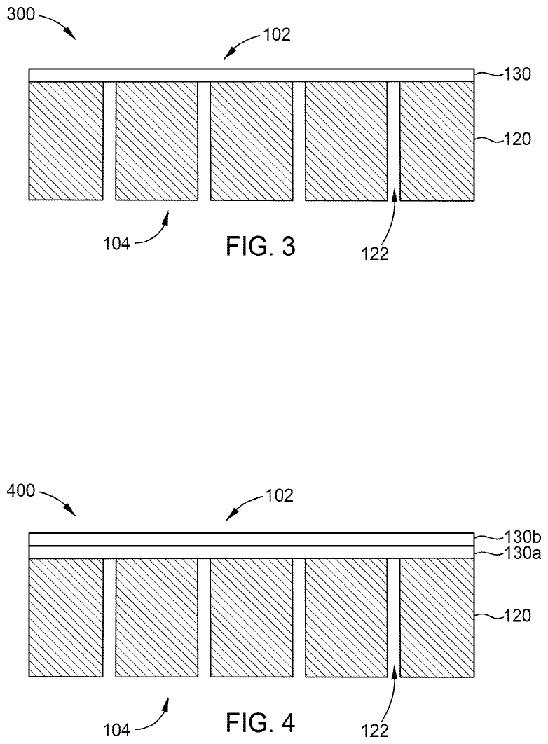

FIG. 3 depicts a cross-sectional view of a dehydration membrane 100, such as a hollow fiber membrane, as described and discussed in one or more embodiments herein. The dehydration membrane 300 contains the porous support layer 120 containing the plurality of pores 122 and the selective layer 130 disposed on or above the porous support layer 120. As shown in FIG. 3, the dehydration membrane 300 contains the selective layer 130 disposed directly on the porous support layer 120. In other embodiments, not shown, one or more other layers can be disposed between the porous support layer 120 and the selective layer 130.

FIG. 4 depicts a cross-sectional view of a dehydration membrane 400, such as another hollow fiber membrane, as described and discussed in one or more embodiments herein. The dehydration membrane 400 contains the porous support layer 120 containing the plurality of pores 122, the selective layer 130a disposed on or above the porous support layer 120, and the selective layer 130b disposed on or above the selective layer 130a. In some embodiments, the dehydration membrane 400 contains similar layers as the dehydration membrane 200, but lacks the non-woven fabric backing 110.

In one or more embodiments, any of the dehydration membranes 100-400 can have a thickness in a range from about 60 μm, about 80 μm, about 100 μm, about 150 μm, about 200 μm, about 250 μm, about 300 μm, about 350 μm, about 400 μm, or about 500 μm to about 550 μm, about 600 μm, about 700 μm, about 800 μm, about 900 μm, about 1 mm, about 1.2 mm, about 1.4 mm, about 1.5 mm, about 1.6 mm, about 1.8 mm, about 2 mm, or thicker. For example, any of the dehydration membranes 100-400 can have a thickness in a range from about 60 μm to about 2 mm, about 60 μm to about 1.5 mm, about 60 μm to about 1.2 mm, about 60 μm to about 800 μm, about 60 μm to about 500 μm, about 60 μm to about 350 μm, about 60 μm to about 200 μm, about 60 μm to about 100 μm, about 200 μm to about 2 mm, about 200 μm to about 1.5 mm, about 200 μm to about 1.2 mm, about 200 μm to about 800 μm, about 200 μm to about 500 μm, about 200 μm to about 350 μm, about 200 μm to about 300 μm, about 200 μm to about 250 μm, about 500 μm to about 2 mm, about 500 μm to about 1.5 mm, about 500 μm to about 1.2 mm, about 500 μm to about 800 μm, about 500 μm to about 600 μm, about 1 mm to about 2 mm, about 1 mm to about 1.8 mm, about 1 mm to about 1.5 mm, about 1 mm to about 1.3 mm, or about 1 mm to about 1.2 mm.

In one or more embodiments, any of the dehydration membranes 100-400 can be configured, manufactured, or otherwise formed as a flat sheet membrane, a spiral-wound membrane, a hollow fiber membrane, a plate-and-frame membrane, or other types of membranes. In some embodiments, any of the dehydration membranes 100-200 can be configured, manufactured, or otherwise formed as a flat sheet membrane. In other embodiments, any of the dehydration membranes 300-400 can be configured, manufactured, or otherwise formed as a hollow fiber membrane.

In one or more embodiments, each of any of the dehydration membranes 100-400, the selective layer 130 (including the selective layers 130a, 130b), the first selective polymeric material, and/or the second selective polymeric material can be selectively permeable to water in the liquid state, the gas state, or a combination thereof. In one or more examples, the selective layer 130 can be configured to separate water (e.g., gaseous water or steam) from a gas mixture and/or a fluid mixture containing water along with a base fluid or base gas. The base fluid or base gas can be or contain methane, ethane, ethene, propylene, other hydrocarbon gases, nitrogen (N₂), argon, carbon dioxide, carbon monoxide, hydrogen sulfide, ammonia, or any combination thereof. In other examples, the selective layer 130 can be configured to separate water (e.g., liquid water or steam) from a liquid mixture and/or a fluid mixture containing water along with a base fluid or base liquid. The base fluid or base liquid can be or contain crude oil, hydrocarbon fuel, one or more organic solvents, one or more hydrocarbon gases, one or more hydrocarbon liquids, one or more product streams in chemical and petrochemical facility, or any combination thereof. In some examples, the base fluid (including base gas and/or base liquid) can be or contain air, natural gas, flue gas, syngas, biogas, a refinery gas, or any combination thereof. The terms “base fluid”, “base liquid”, and “base gas” describe the fluid, liquid, or gas, respectively, before being separated by processes described and discussed herein. The terms “base fluid”, “base liquid”, and “base gas” are used independently of what the chemical pH value is of the base fluid, base liquid, or base gas.

In other embodiments, a method for separating water from a fluid is provided and includes introducing a fluid mixture containing water and a base fluid to the feed side 102 of any of the dehydration membranes 100-400, removing the water from the feed side 102 by passing the water through the dehydration membranes 100-400 while retaining the base fluid on the feed side 102. In some examples, the fluid mixture contains air, natural gas, flue gas, syngas, biogas, a refinery gas, or any combination thereof. In other examples, the fluid mixture contains crude oil, fuel, organic solvent, a hydrocarbon gas, a hydrocarbon liquid, a product stream in a chemical or petrochemical facility, or any combination thereof.

In one or more embodiments, the non-woven fabric backing 110 can be or contain one or more materials which include one or more fibers, one or more natural polymers, one or more synthetic polymers, or any combination thereof. For example, the non-woven fabric backing 110 can be or contain a plurality of fibers. The fibers can be or contain one or more materials selected from polyethylene terephthalate, polyester, polypropylene, polyethylene, polyamide, polyimide, fiberglass, cellulose, regenerated cellulose, wood pulp, cotton, wool, carbon, or any combination thereof.

The non-woven fabric backing 110 can have a thickness in a range from about 10 μm, about 20 μm, about 35 μm, about 50 μm, about 100 μm, about 150 μm, about 200 μm, about 250 μm, or about 300 μm to about 350 μm, about 400 μm, about 500 μm, about 600 μm, about 700 μm, about 800 μm, about 900 μm, about 1 mm, or thicker. For example, the non-woven fabric backing 110 can have a thickness in a range from about 10 μm to about 1 mm, about 50 μm to about 1 mm, about 100 μm to about 1 mm, about 250 μm to about 1 mm, about 500 μm to about 1 mm, about 600 μm to about 1 mm, about 750 μm to about 1 mm, about 900 μm to about 1 mm, about 50 μm to about 750 μm, about 100 μm to about 750 μm, about 250 μm to about 750 μm, about 500 μm to about 750 μm, about 600 μm to about 750 μm, about 50 μm to about 500 μm, about 100 μm to about 500 μm, about 250 μm to about 500 μm, or about 400 μm to about 500 μm.

In one or more embodiments, the porous support layer 120 can be or contain one or more porous polymeric materials. In some examples, the polymeric materials can be or include polyamide, polyimide, polyester, sulfone-based polymer, polymeric organosilicone, fluorinated polymer, chlorinated polymer, polyacrylonitrile, polybenzimidazole, cellulose-based polymer, oligomers thereof, complexes thereof, derivatives thereof, or any combination thereof. Exemplary polymeric materials can be or include one or more polysulfones, one or more polyphenylsulfones, one or more polyethersulfones, one or more polydimethylsiloxanes, one or more polytetrafluoroethylenes, one or more polyvinylidene fluorides, one or more polyvinyl chlorides, one or more cellulose acetates, oligomers thereof, complexes thereof, derivatives thereof, or any combination thereof.

The porous support layer 120 can have a thickness in a range from about 10 μm, about 20 μm, about 25 μm, about 30 μm, about 50 μm, about 75 μm, about 90 μm, or about 100 μm to about 120 μm, about 150 μm, about 180 μm, about 200 μm, about 250 μm, about 300 μm, about 350 μm, about 400 μm, about 450 μm, about 500 μm, or thicker. For example, the porous support layer 120 can have a thickness in a range from about 10 μm to about 500 μm, about 10 μm to about 400 μm, about 10 μm to about 350 μm, about 10 μm to about 300 μm, about 10 μm to about 250 μm, about 10 μm to about 200 μm, about 10 μm to about 150 μm, about 10 μm to about 120 μm, about 10 μm to about 100 μm, about 10 μm to about 80 μm, about 10 μm to about 50 μm, about 10 μm to about 35 μm, about 10 μm to about 20 μm, about 50 μm to about 500 μm, about 50 μm to about 400 μm, about 50 μm to about 350 μm, about 50 μm to about 300 μm, about 50 μm to about 250 μm, about 50 μm to about 200 μm, about 50 μm to about 150 μm, about 50 μm to about 120 μm, about 50 μm to about 100 μm, about 50 μm to about 80 μm, about 50 μm to about 65 μm, about 100 μm to about 500 μm, about 100 μm to about 400 μm, about 100 μm to about 350 μm, about 100 μm to about 300 μm, about 100 μm to about 250 μm, about 100 μm to about 200 μm, about 100 μm to about 150 μm, or about 100 μm to about 120 μm.

In one or more embodiments, the porous support layer 120 can have a plurality of pores 122 therethrough. The pores 122 can extend throughout the porous support layer 120. In some examples, the pores 122 extend between the lower and upper surfaces of the porous support layer 120. The plurality of pores 122 can have an average pore size in a range from about 1 nm, about 2 nm, about 5 nm, about 10 nm, about 20 nm, or about 25 nm to about 30 nm, about 40 nm, about 50 nm, about 60 nm, about 80 nm, or about 100 nm (about 0.1 μm), or greater. For example, the average pore size of the pores 122 can be about 1 nm to about 100 nm, about 5 nm to about 100 nm, about 10 nm to about 100 nm, about 20 nm to about 100 nm, about 50 nm to about 100 nm, about 75 nm to about 100 nm, about 1 nm to about 50 nm, about 5 nm to about 50 nm, about 10 nm to about 50 nm, about 20 nm to about 50 nm, about 50 nm to about 35 nm, about 1 nm to about 20 nm, about 2 nm to about 20 nm, about 5 nm to about 20 nm, about 12 nm to about 20 nm, about 15 nm to about 20 nm, or about 18 nm to about 20 nm.

In one or more embodiments, the selective layer 130 contains one or more selective polymeric materials, such as one or more ethylene vinyl alcohol polymeric materials. Additionally, each of the selective layers 130 and/or each of the selective polymeric material can independently and optionally contain one or more polyelectrolytes, one or more cross-linking agents, one or more functionalization agent, one or more catalysts, one or more types of metal nanoparticles, or any combination thereof.

Each of the selective layers 130 can independently have a thickness in a range from about 1 nm, about 50 nm, about 100 nm, about 200 nm, about 500 nm, about 800 nm, about 1 μm, about 2 μm, or about 5 μm to about 8 μm, about 10 μm, about 20 μm, about 30 μm, about 40 μm, about 50 μm, about 60 μm, about 70 μm, about 80 μm, about 90 μm, about 100 μm, or thicker. For example, each of the selective layers 130 can independently have a thickness in a range from about 1 nm to about 100 μm, about 1 nm to about 80 μm, about 1 nm to about 65 μm, about 1 nm to about 50 μm, about 1 nm to about 40 μm, about 1 nm to about 30 μm, about 1 nm to about 20 μm, about 1 nm to about 10 μm, about 1 nm to about 1 μm, about 1 nm to about 500 nm, about 1 nm to about 100 nm, about 1 nm to about 50 nm, about 500 nm to about 100 μm, about 500 nm to about 80 μm, about 500 nm to about 65 μm, about 500 nm to about 50 μm, about 500 nm to about 40 μm, about 500 nm to about 30 μm, about 500 nm to about 20 μm, about 500 nm to about 10 μm, about 500 nm to about 1 μm, about 1 μm to about 100 μm, about 1 μm to about 80 μm, about 1 μm to about 50 μm, about 1 μm to about 40 μm, about 1 μm to about 30 μm, about 1 μm to about 20 μm, or about 1 μm to about 10 μm.

In one or more examples, each of the selective layers 130 and/or the selective polymeric material can independently contain one or more ethylene vinyl alcohol copolymers. In some examples, the ethylene vinyl alcohol polymeric material contains an ethylene vinyl alcohol copolymer which has an ethylene to vinyl alcohol molar ratio in a range from about 1:19 to about 19:1, about 1:12 to about 12:1, about 1:8 to about 8:1, about 1:6 to about 6:1, about 1:5 to about 5:1, or about 1:4 to about 4:1.

The ethylene vinyl alcohol polymeric material and/or the ethylene vinyl alcohol copolymer can have an ethylene content in a range from about 5 mole percent (mol %), about 10 mol %, about 15 mol %, about 20 mol %, about 25 mol %, about 30 mol %, or about 40 mol % to about 45 mol %, about 50 mol %, about 60 mol %, about 70 mol %, about 80 mol %, about 85 mol %, about 90 mol %, or about 95 mol %. For example, the ethylene vinyl alcohol polymeric material and/or the ethylene vinyl alcohol copolymer can have an ethylene content in a range from about 5 mol % to about 95 mol %, about 5 mol % to about 90 mol %, about 5 mol % to about 80 mol %, about 5 mol % to about 75 mol %, about 5 mol % to about 60 mol %, about 5 mol % to about 50 mol %, about 5 mol % to about 40 mol %, about 5 mol % to about 30 mol %, about 5 mol % to about 25 mol %, about 5 mol % to about 15 mol %, about 5 mol % to about 10 mol %, about 20 mol % to about 95 mol %, about 20 mol % to about 90 mol %, about 20 mol % to about 80 mol %, about 20 mol % to about 75 mol %, about 20 mol % to about 60 mol %, about 20 mol % to about 50 mol %, about 20 mol % to about 40 mol %, about 20 mol % to about 30 mol %, about 20 mol % to about 25 mol %, about 50 mol % to about 95 mol %, about 50 mol % to about 90 mol %, about 50 mol % to about 80 mol %, about 50 mol % to about 75 mol %, or about 50 mol % to about 60 mol %.

In some examples, each of the selective layers 130 and/or the selective polymeric materials (e.g., the ethylene vinyl alcohol polymeric material) can independently contain one or more catalysts. The catalyst can be or contain one or more acids or one or more bases. Exemplary acidic catalysts can be or include hydrochloric acid, sulfuric acid, phosphoric acid, nitric acid, acetic acid, boric acid, hydrofluoric acid, oxalic acid, citric acid, carbonic acid, p-toluenesulfonic acid, salts thereof, complexes thereof, or any combination thereof. Exemplary basic catalysts can be or include lithium hydroxide, sodium hydroxide, potassium hydroxide, rubidium hydroxide, cesium hydroxide, magnesium hydroxide, calcium hydroxide, strontium hydroxide, barium hydroxide, lithium carbonate, lithium bicarbonate, sodium carbonate, sodium bicarbonate, potassium carbonate, potassium bicarbonate, rubidium carbonate, rubidium bicarbonate, cesium carbonate, cesium bicarbonate, lithium methoxide, lithium ethylate, sodium methoxide, sodium ethylate, potassium methoxide, potassium ethylate, magnesium methoxide, magnesium ethylate, calcium methoxide, calcium ethylate, salts thereof, complexes thereof, or any combination thereof.

In one or more embodiments, each of the ethylene vinyl alcohol polymeric materials can independently have at least one of the chemical formulas represented by Formulas (1), (2a), (2b), (3a), (3b), (4a), (4b), (5a), (5b), (6a), or (6b):

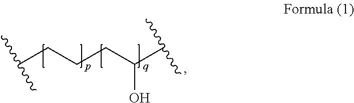

wherein each of p and q of Formula (1) is independently an integer in a range from 1 to about 32,000, such as in a range from about 100 to about 32,000;

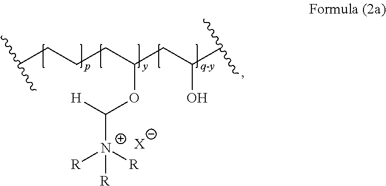

wherein each of p and q of Formula (2a) is independently an integer in a range from 1 to about 32,000, such as in a range from about 100 to about 32,000, each y of Formula (2a) is independently an integer in a range from 1 to about 6,400, each R of Formula (2a) is independently an alkyl group with chemical formula of CₙH₂ₙ₊₁, wherein n is an integer in a range from 0 to about 18, and X of Formula (2a) is fluoride, chloride, bromide, or iodide;

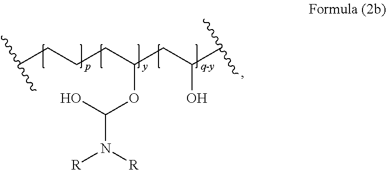

wherein each of p and q of Formula (2b) is independently an integer in a range from 1 to about 32,000, such as in a range from about 100 to about 32,000, each y of Formula (2b) is independently an integer in a range from 1 to about 6,400, and each R of Formula (2b) is independently an alkyl group with chemical formula of CₙH₂ₙ₊₁, wherein n is an integer in a range from 0 to about 18, such as a C₁-C₁₈ alkyl;

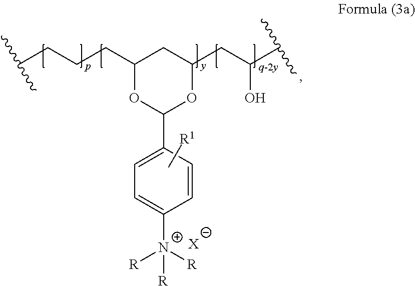

wherein each of p and q of Formula (3a) is independently an integer in a range from 1 to about 32,000, such as in a range from about 100 to about 32,000, each y of Formula (3a) is independently an integer in a range from 1 to about 6,400, and each R of Formula (3a) is independently an alkyl group with chemical formula of CₙH₂ₙ₊₁, wherein n is an integer in a range from 0 to about 18, and R¹ of Formula (3a) is an alkyl group with formula CₙH₂ₙ₊₁ and n is an integer in a range from 0 to about 18, such as a C₁-C₁₈ alkyl, or an alkyl hydroxyl group with formula CₙH₂ₙOH and n is an integer in a range from 0 to about 18, such as a C₁-C₁₀ alcohol; and X of Formula (3a) is fluoride, chloride, bromide, or iodide;

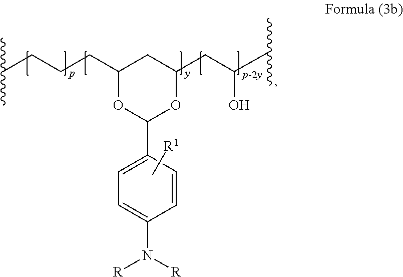

wherein each p of Formula (3b) is independently an integer in a range from 1 to about 32,000, such as in a range from about 100 to about 32,000, each y of Formula (3b) is independently an integer in a range from 1 to about 6,400, and each R of Formula (3b) is independently an alkyl group with chemical formula of CₙH₂ₙ₊₁, wherein n is an integer in a range from 0 to about 18, such as a C₁-C₁₈ alkyl, and R¹ of Formula (3b) is an alkyl group with formula CₙH₂ₙ₊₁ and n is an integer in a range from 0 to about 18, such as a C₁-C₁₈ alkyl, or an alkyl hydroxyl group with formula CₙH₂ₙOH and n is an integer in a range from 0 to about 18, such as a C₁-C₁₈ alcohol;

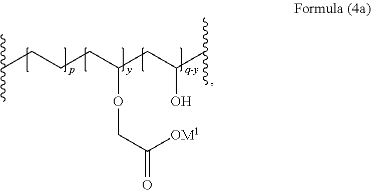

wherein each of p and q of Formula (4a) is independently an integer in a range from 1 to about 32,000, such as in a range from about 100 to about 32,000, each y of Formula (4a) is independently an integer in a range from 1 to about 6,400, and M¹ of Formula (4a) is hydrogen, lithium, sodium, potassium, cesium, or any combination thereof;

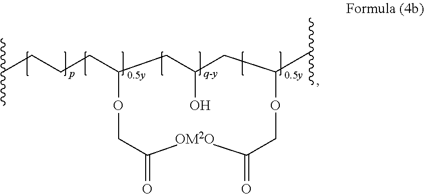

wherein each of p and q of Formula (4b) is independently an integer in a range from 1 to about 32,000, such as in a range from about 100 to about 32,000, each y of Formula (4b) is independently an integer in a range from 1 to about 6,400, and M² of Formula (4b) is magnesium, calcium, or any combination thereof;

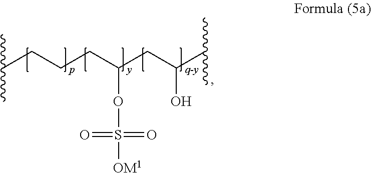

and
wherein each of p and q of Formula (5a) is independently an integer in a range from 1 to about 32,000, such as in a range from about 100 to about 32,000, each y of Formula (5a) is independently an integer in a range from 1 to about 6,400, and M¹ of Formula (5a) is hydrogen, lithium, sodium, potassium, cesium, or any combination thereof;

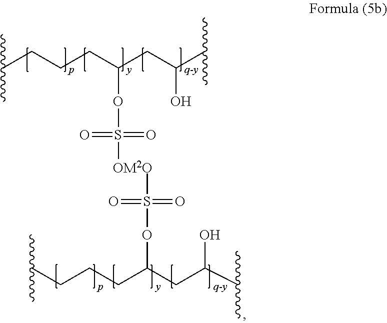

and
wherein each of p and q of Formula (5b) is independently an integer in a range from 1 to about 32,000, such as in a range from about 100 to about 32,000, each y of Formula (5b) is independently an integer in a range from 1 to about 6,400, and M² of Formula (5b) is magnesium, calcium, or any combination thereof;

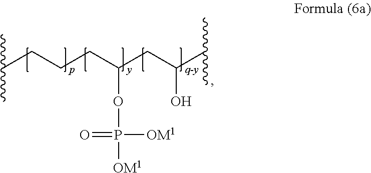

wherein each of p and q of Formula (6a) is independently an integer in a range from 1 to about 32,000, such as in a range from about 100 to about 32,000, each y of Formula (6a) is independently an integer in a range from 1 to about 6,400, and M¹ of Formula (6a) is hydrogen, lithium, sodium, potassium, cesium, or any combination thereof;

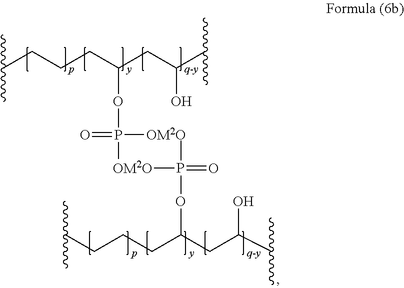

wherein each of p and q of Formula (6b) is independently an integer in a range from 1 to about 32,000, such as in a range from about 100 to about 32,000, each y of Formula (6b) is independently an integer in a range from 1 to about 6,400, and M² of Formula (6b) is magnesium, calcium, or any combination thereof.

In some embodiments, each of the ethylene vinyl alcohol polymeric materials can independently have at least one of the chemical formulas represented by Formulas (7), (8), (9), (10), and (11):

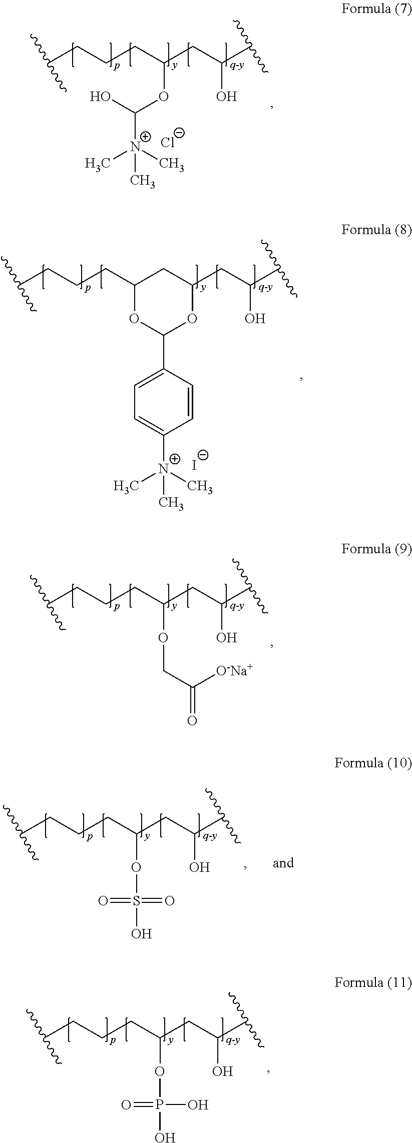

wherein each of p and q of Formulas (7), (8), (9), (10), and (11) is independently an integer in a range from 1 to about 32,000, such as in a range from about 100 to about 32,000, and each y of Formulas (7), (8), (9), (10), and (11) is independently an integer in a range from 1 to about 6,400, such as in a range from about 100 to about 6,400.

In one or more embodiments, each of the ethylene vinyl alcohol polymeric materials can independently have a molar ratio of p and q in a range from about 1 to 19 to about 19 to 1, such as from about 1 to 4 to about 4 to 1. Also, each of the ethylene vinyl alcohol polymeric materials can independently have a molar ratio of y and q in a range from about 1 to 200 to about 199 to 200, such as from about 1 to 100 to about 1 to 5. In some examples, the ethylene vinyl alcohol polymeric material can have a weight average molecular weight in a range from about 600 Daltons to about 5,000,000 Daltons.

In some embodiments, each of the ethylene vinyl alcohol polymeric materials can independently have a molar ratio of ethylene and vinyl alcohol of about 1 to 19 to about 19 to 1, such as about 1 to 4 and about 4 to 1. In some examples, the ethylene vinyl alcohol polymeric material can have an ethylene content in a range from about 5 mol % to about 95 mol %, such as from about 20 mol % to about 80 mol %.

In one or more embodiments, each of the ethylene vinyl alcohol polymeric materials can independently be or include a reaction product prepared from a functional or cross-linking group. In some examples, the functional or cross-linking group contains an aldehyde, a dialdehyde, a diepoxide, or any combination thereof.

In other embodiments, the selective layer 130 can be or contain an ethylene vinyl alcohol polymeric material which is a reaction product prepared from a functional or cross-linking group along with one or more ethylene vinyl alcohol polymers. The functional or cross-linking group contains an aldehyde is represented by the formula H(O)CR, wherein R has at least one of the chemical formulas represented by Formulas (12a)-(12i):

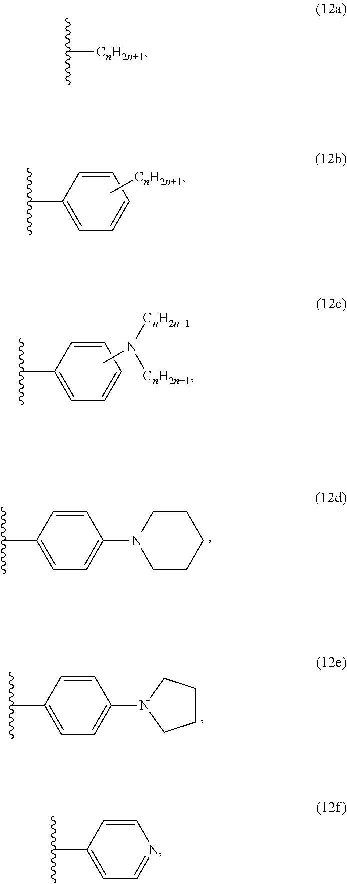

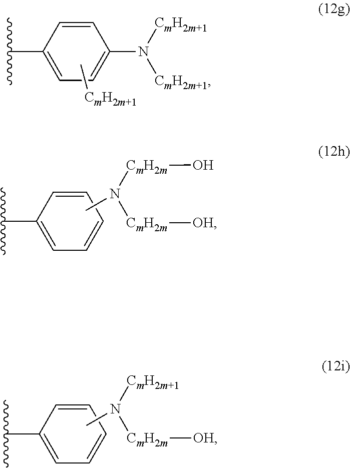

or any combination thereof, and wherein n of Formulas (12a)-(12c) is an integer in a range from 0 to about 18, and m of Formulas (12g)-(12i) is an integer in a range from 1 to about 18.

In some embodiments, the ethylene vinyl alcohol polymeric material can be or contain a reaction product prepared from a functional or cross-linking group along with one or more ethylene vinyl alcohol polymers. The functional or cross-linking group contains a dialdehyde is represented by the formula H(O)CRC(O)H, wherein R has at least one of the chemical formulas represented by Formulas (13a)-(13b):

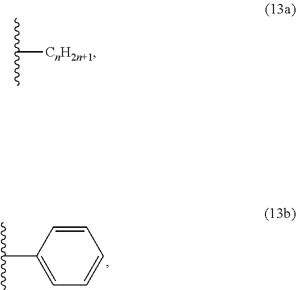

or any combination thereof, and wherein n of Formula (13a) is an integer in a range from 0 to about 18.

In one or more embodiments, the ethylene vinyl alcohol polymeric material can be or contain a reaction product prepared from a functional or cross-linking group. The functional or cross-linking group contains a diepoxide having the chemical formula represented by Formulas (14)-(15):

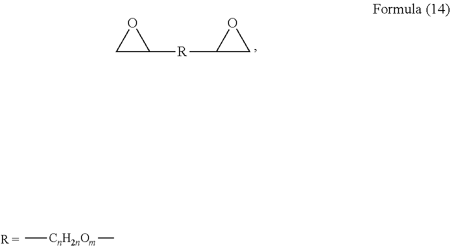

wherein R is an alkyl group of Formula (14), n of Formula (14) is an integer in a range from 0 to about 18, and m of Formula (14) is an integer in a range from 0 to about 4, and/or

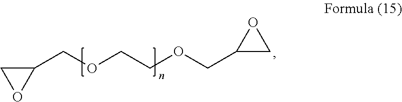

wherein n of Formula (15) is an integer in a range from 1 to about 1,000, such as about 10 to about 1,000.

In some embodiments, each of the selective layers 130 and/or the selective polymeric materials (e.g., the ethylene vinyl alcohol polymeric material) can independently contain one or more cross-linking agents and one or more catalysts at a predetermined weight ratio. For example, the cross-linking agent and the catalyst can be at a weight ratio in a range from about 1:100,000 to about 1:1, about 1:50,000 to about 1:1, about 1:30,000 to about 1:1, about 1:20,000 to about 1:1, about 1:10,000 to about 1:1, about 1:9,999 to about 1:1, about 1:5,000 to about 1:1, about 1:2,000 to about 1:1, or about 1:1,000 to about 1:1 within the selective layer 130.

Each of the ethylene vinyl alcohol polymeric material and/or the ethylene vinyl alcohol copolymer can independently have a weight average molecular weight of greater than 500 Daltons, greater than 600 Daltons, greater than 700 Daltons, greater than 800 Daltons, about 1,000 Daltons, about 10,000 Daltons, about 100,000 Daltons, about 500,000 Daltons, or about 1,000,000 Daltons to about 1,500,000 Daltons, about 2,000,000 Daltons, about 3,000,000 Daltons, about 4,000,000 Daltons, about 4,500,000 Daltons, about 4,900,000 Daltons, or less than 5,000,000 Daltons. For example, each of the ethylene vinyl alcohol polymeric material and/or the ethylene vinyl alcohol copolymer can independently have a weight average molecular weight of greater than 500 Daltons and less than 5,000,000 Daltons, greater than 600 Daltons and less than 5,000,000 Daltons, greater than 800 Daltons and less than 5,000,000 Daltons, about 1,000 Daltons and less than 5,000,000 Daltons, greater than 1,000 Daltons and less than 5,000,000 Daltons, about 10,000 Daltons and less than 5,000,000 Daltons, about 100,000 Daltons and less than 5,000,000 Daltons, about 1,000,000 Daltons and less than 5,000,000 Daltons, about 2,000,000 Daltons and less than 5,000,000 Daltons, about 3,000,000 Daltons and less than 5,000,000 Daltons, about 4,000,000 Daltons and less than 5,000,000 Daltons, or about 4,500,000 Daltons and less than 5,000,000 Daltons.

In one or more embodiments, each of the selective layers 130 and/or the selective polymeric materials (e.g., the ethylene vinyl alcohol polymeric material) can independently contain one or more polyelectrolytes having repeating units containing one or more one ionic or ionizable groups. In some examples, the polyelectrolyte can be or contain a polymethyleneamine, a reaction product from a polymethyleneamine and an acid, a polyvinylamine, a reaction product from a polyvinylamine and an acid, a polyallylamine, a reaction product from a polyallylamine and an acid, a polyethylenimine, a reaction product from a polyethylenimine and an acid, a branched polyethylenimine, a reaction product from a branched polyethylenimine and an acid, a poly(diallyldimethylammonium chloride), a poly(4-styrenesulfonic acid), a reaction product from a poly(4-styrenesulfonic acid) and a base, a poly(vinyl sulfonic acid), a reaction product from a poly(vinyl sulfonic acid) and a base, a poly(acrylic acid), a reaction product from a poly(acrylic acid) and a base, or any combination thereof.

Exemplary acids for preparing the polyelectrolyte can be or include hydrochloric acid, sulfuric acid, phosphoric acid, nitric acid, acetic acid, boric acid, hydrofluoric acid, hydrobromic acid, hydroiodic acid, oxalic acid, citric acid, p-toluenesulfonic acid, carbonic acid, salts thereof, derivatives thereof, or any combination thereof. Exemplary bases for preparing the polyelectrolyte can be or include lithium hydroxide, sodium hydroxide, potassium hydroxide, rubidium hydroxide, cesium hydroxide, magnesium hydroxide, calcium hydroxide, strontium hydroxide, barium hydroxide, lithium carbonate, lithium bicarbonate, sodium carbonate, sodium bicarbonate, potassium carbonate, potassium bicarbonate, rubidium carbonate, rubidium bicarbonate, cesium carbonate, cesium bicarbonate, salts thereof, or any combination thereof.

In one or more embodiments, each of the selective layers 130 and/or the selective polymeric materials (e.g., the ethylene vinyl alcohol polymeric material) can independently contain one or more polyelectrolytes. Exemplary polyelectrolytes can be or include poly(allylamine hydrochloride), linear polyethylenimine, poly(sodium 4-styrenesulfonate), poly(vinyl sulfate) sodium salt, or any combination thereof.

In some embodiments, each of the selective layers 130 and/or the selective polymeric materials (e.g., the ethylene vinyl alcohol polymeric material) can independently contain one or more polyelectrolytes having at least one of the chemical formulas represented by Formulas (16), (17), (18), (19a), (19b), (20), (21), (22), and (23):

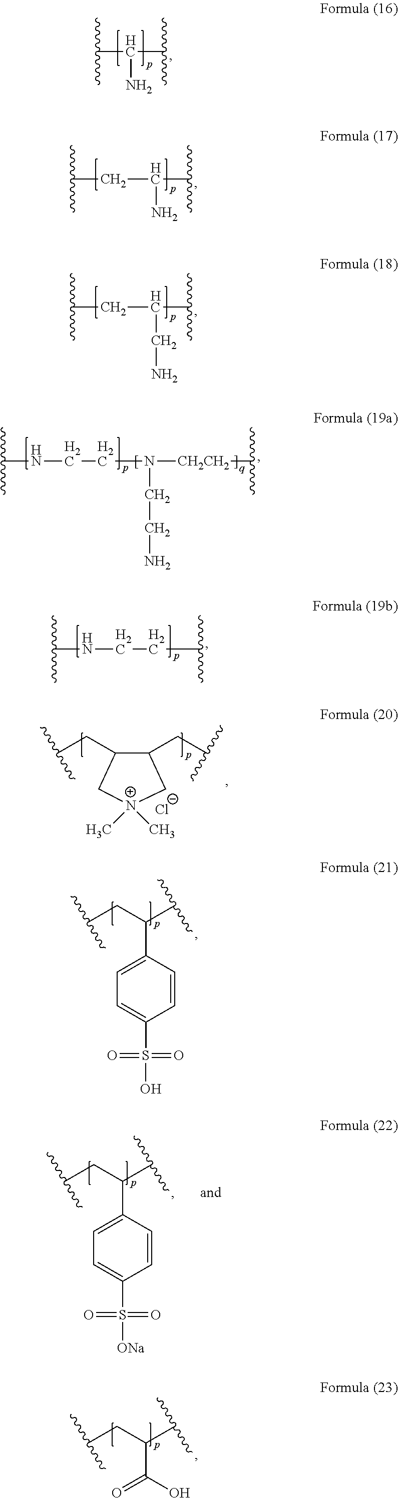

wherein each of p and each of q, where applicable, of Formulas (16), (17), (18), (19a), (19b), (20), (21), (22), or (23) is independently an integer in a range from 1 to about 32,000, such as in a range from about 100 to about 32,000.

In one or more embodiments, the polyelectrolyte can have a weight average molecular weight in a range from greater than 500 Daltons to about 5,000,000 Daltons, about 600 Daltons to about 5,000,000 Daltons, about 1,000 Daltons to about 5,000,000 Daltons, about 10,000 Daltons to about 5,000,000 Daltons, about 100,000 Daltons to about 5,000,000 Daltons, about 1,000,000 Daltons to about 5,000,000 Daltons, about 2,000,000 Daltons to about 5,000,000 Daltons, about 3,000,000 Daltons to about 5,000,000 Daltons, about 4,000,000 Daltons to about 5,000,000 Daltons, or about 4,500,000 Daltons to about 5,000,000 Daltons.

In some embodiments, the ethylene vinyl alcohol polymeric material can include one or more polyelectrolytes with a positive charge and one or more polyelectrolytes with a negative charge. The polyelectrolytes can have a weight ratio of the polyelectrolytes with the positive charge relative to the polyelectrolytes with the negative charge in a range from about 1 to 49 to about 49 to 200, such as from about 1 to 5 to about 5 to 1.

In one or more embodiments, each of the selective layers 130 and/or the selective polymeric materials (e.g., the ethylene vinyl alcohol polymeric material) can independently contain metal nanoparticles. The metal nanoparticles can be or contain zinc nanoparticles, zinc oxide nanoparticles, copper nanoparticles, copper oxide nanoparticles, titanium nanoparticles, titanium oxide nanoparticles, silver nanoparticles, gold nanoparticles, or any combination thereof. In some embodiments, the metal nanoparticles can have one or more surface-treatment coatings disposed on an outer surface of each of the metal nanoparticles. The surface-treatment coating can be or contain one or more organo-functional silanes (e.g., 3-(trimethoxysilyl) propyl methacrylate), one or more hydrophilic polymers (e.g., polyvinylpyrrolidone), one or more hydrophilic monomers (e.g., methyl methacrylate), or any combination thereof.

Each of the selective layers 130 can have a weight ratio of the metal nanoparticles to the ethylene vinyl alcohol polymeric material in a range from about 1 to 5,000 to about 1 to 4, about 1 to 3,000 to about 1 to 10, or about 1 to 1,000 and about 1 to 19.

In one or more embodiments, one or more of the selective layers 130 can be prepared by combining the desired components to produce a selective layer material mixture, coating the selective layer material mixture to the porous support layer 120, and drying the selective layer material mixture to produce the selective layer 130 disposed on the porous support layer 120. The selective layer material mixture can be prepared by combining one or more ethylene vinyl alcohol copolymers with any one or more of: one or more polyelectrolytes, one or more cross-linking agents, one or more catalysts, one or more metal nanoparticles, one or more solvents, or any combination thereof. Exemplary solvents can be or include water, methanol, ethanol, isopropyl alcohol, propyl alcohol, dichloromethane, tetrahydrofuran, ethyl acetate, acetonitrile, dimethylformamide, dimethyl sulfoxide, dimethylacetamide, 1-methyl-2-pyrrolidinoneacetone, hexamethylphosphoric triamide, ethylene glycol, diethylene glycol, ethylene carbonate, propylene carbonate, pyridine, or any combination thereof.

Once the desired components are combined with the ethylene vinyl alcohol copolymer, the selective layer material mixture can be heated, cooled, or otherwise maintained at a temperature in a range from about 1 °C, about 20 °C, about 30 °C, or about 50 °C to about 60 °C, about 70 °C, about 80 °C, about 100 °C, about 120 °C, about 135 °C, about 150 °C, or greater. The selective layer material mixture can be maintained at a pressure in a range from about 14.7 psia (pound per square inch absolute pressure), about 20 psia, about 30 psia, about 50 psia, about 60 psia, or about 80 psia, to about 10 psia, about 200 psia, about 300 psia, about 400 psia, about 500 psia. The selective layer material mixture can be maintained at the desired temperature and/or pressure for about 1 minute to about 24 hours.

In one or more examples, the selective layer material mixture is maintained at a pressure in a range from about 14.7 psia to about 500 psia and a temperature in a range from about 1 °C to about 120 °C for about 1 minute to about 24 hours. For example, the selective layer material mixture can be maintained at a pressure of about 14.7 psia at about 120 °C for about 10 minutes.

In some embodiments, the selective layer material mixture can be coated to or otherwise disposed on the porous support layer 120 by any coating or deposition technique or process. Exemplary coating techniques or processes can include knife casting, dip casting, or spray coating. Once the selective layer material mixture is disposed on the porous support layer 120, the selective layer material mixture is dried and/or the solvent is removed to produce the selective layer 130. The selective layer material mixture disposed on the porous support layer 120 can be heated, cooled, or otherwise maintained at a temperature in a range from about 1 °C, about 20 °C, about 30 °C, or about 50 °C to about 60 °C, about 70 °C, about 80 °C, about 100 °C, about 120 °C, about 135 °C, about 150 °C, about 170 °C, about 180 °C, about 190 °C, about 199 °C, about 200 °C, or greater. In one or more examples, selective layer material mixture is dried to produce the selective layer 130 at a temperature in a range from about 1 °C to about 199 °C for about 1 minute to about 24 hours.

In other embodiments, a method for separating water from a fluid (e.g., gas, liquid, or a combination thereof) is provided and includes introducing a fluid mixture containing water and a base fluid (e.g., gas, liquid, or a combination thereof) to the feed side 102 of any one of the dehydration membranes 100-400, passing the water through any of the dehydration membranes 100-400 to remove the water from the feed side 102 while retaining the base fluid on the feed side 102, and recovering the water from the permeate side 104 of any of the dehydration membrane 100-400. In one or more examples, the base fluid can be in a liquid state, a gas state, or a combination thereof, and independently, the water can be in a liquid state, a gas state, or a combination thereof.

In some examples, the fluid mixture can be or contain air, natural gas, flue gas, syngas, biogas, a refinery gas, or any combination thereof. In other examples, the fluid mixture can be or contain crude oil, fuel, organic solvent, a hydrocarbon gas, a hydrocarbon liquid, a product stream in a chemical or petrochemical facility, or any combination thereof. The base fluid can be or contain methane, ethane, ethene, propylene, other hydrocarbon gases, nitrogen (N₂), argon, carbon dioxide, carbon monoxide, hydrogen sulfide, ammonia, or any combination thereof.

The feed side 102 of the dehydration membrane 100-400 is maintained at a pressure equal to or greater than a pressure of the permeate side 104 of the dehydration membrane 100-400. In one or more embodiments, the feed side 102 of the dehydration membrane 100-400 can be maintained at a pressure in a range from about 14.7 psia, about 15 psia, about 20 psia, about 25 psia, about 30 psia, about 50 psia, about 65 psia, about 80 psia, about 95 psia, or about 100 psia to about 110 psia, about 130 psia, about 150 psia, about 180 psia, about 200 psia, about 250 psia, about 300 psia, about 500 psia, about 600 psia, about 750 psia, about 900 psia, about 1,000 psia, or greater. For example, the feed side 102 can be maintained at a pressure in a range from about 14.7 psia to about 1,000 psia, about 50 psia to about 1,000 psia, about 100 psia to about 1,000 psia, about 200 psia to about 1,000 psia, about 350 psia to about 1,000 psia, about 500 psia to about 1,000 psia, about 750 psia to about 1,000 psia, about 900 psia to about 1,000 psia, about 14.7 psia to about 800 psia, about 50 psia to about 800 psia, about 100 psia to about 800 psia, about 200 psia to about 800 psia, about 350 psia to about 800 psia, about 500 psia to about 800 psia, about 750 psia to about 800 psia, about 14.7 psia to about 500 psia, about 50 psia to about 500 psia, about 100 psia to about 500 psia, about 200 psia to about 500 psia, about 350 psia to about 500 psia, about 14.7 psia to about 200 psia, about 50 psia to about 200 psia, about 100 psia to about 200 psia, or about 150 psia to about 200 psia.

In some embodiments, the permeate side 104 of the dehydration membrane 100-400 can be maintained at a pressure in a range from about 0.00001 psia, about 0.0001 psia, about 0.001 psia, or about 0.01 psia to about 0.1 psia, about 1 psia, about 5 psia, about 10 psia, about 20 psia, about 35 psia, about 50 psia, or greater. For example, the permeate side 104 can be maintained at a pressure in a range from about 0.00001 psia to about 50 psia, about 0.0001 psia to about 50 psia, about 0.001 psia to about 50 psia, about 0.01 psia to about 50 psia, about 0.1 psia to about 50 psia, about 1 psia to about 50 psia, about 10 psia to about 50 psia, about 0.00001 psia to about 1 psia, about 0.0001 psia to about 1 psia, about 0.001 psia to about 1 psia, about 0.01 psia to about 1 psia, about 0.1 psia to about 1 psia, about 0.00001 psia to about 0.1 psia, about 0.0001 psia to about 0.1 psia, about 0.001 psia to about 0.1 psia, or about 0.01 psia to about 0.1 psia.

In one or more embodiments, when introduced into the feed side 102, the fluid mixture can be heated or otherwise maintained at a temperature in a range from about 20 °C, about 23 °C, about 25 °C, about 30 °C, about 40 °C, about 50 °C, about 60 °C, or about 70 °C to about 80 °C, about 90 °C, about 100 °C, about 110 °C, about 120 °C, about 130 °C, about 140 °C, about 150 °C, about 175 °C, about 200 °C, or greater. For example, the fluid mixture can be heated or otherwise maintained at a temperature in a range from about 20 °C to about 200 °C, about 20 °C to about 150 °C, about 20 °C to about 140 °C, about 20 °C to about 130 °C, about 20 °C to about 120 °C, about 20 °C to about 110 °C, about 20 °C to about 100 °C, about 20 °C to about 80 °C, about 20 °C to about 50 °C, about 20 °C to about 40 °C, about 40 °C to about 200 °C, about 40 °C to about 150 °C, about 40 °C to about 140 °C, about 40 °C to about 130 °C, about 40 °C to about 120 °C, about 40 °C to about 110 °C, about 40 °C to about 100 °C, about 40 °C to about 80 °C, about 40 °C to about 60 °C, about 40 °C to about 50 °C, about 80 °C to about 200 °C, about 80 °C to about 150 °C, about 80 °C to about 140 °C, about 80 °C to about 130 °C, about 80 °C to about 120 °C, about 80 °C to about 110 °C, or about 80 °C to about 100 °C when introduced into the feed side 102.

In some embodiments, air can be dehumidified by any one of the dehydration membranes 100-400. For example, water can be separated or otherwise at least partially removed from ambient or humid air to prepare a dehumidified air which has less water or moisture than the ambient or humid air. In one or more examples, the humid air is flowed or otherwise introduced to the feed side 102 of the dehydration membrane 100-400, water is removed from the feed side 102 and recovered at the permeate side 104, and a dehumidified air is retained on the feed side 102. In some examples, the dehumidified air retained on the feed side 102 is transferred, supplied to, or otherwise introduced into another system, such as a heating system, a ventilation system, an air conditioning system, or any other system in which dehumidified air is desired.

### EXAMPLES

In order to provide a better understanding of the foregoing discussion, the following non-limiting examples are offered. Although the examples can be directed to specific embodiments, they are not to be viewed as limiting the invention or claimed subject matter in any specific respect.

The synergetic effects due to the dehydration membranes described and discussed herein have been achieved. The dehydration membranes can be prepared as highlighted by the following Examples 1-21.

Example 1: A dehydration membrane is suitable for removing water from gases such as air and liquids. The dehydration membrane contains (a) a non-woven fabric backing containing of polyester or polypropylene; (b) a porous support membrane comprising of polysulfone or polyethersulfone with average pore size in a range from about 10 nm to about 0.1 μm; and (c) one selective layer containing of an ethylene vinyl alcohol copolymer with thickness in a range from about 50 nm to about 10 μm. During the preparation of the casting solution, an ethylene vinyl alcohol copolymer is dissolved in a solvent or a solvent mixture. Then gas bubbles and solid particles are removed from the casting solution with a centrifuge, and the casting solution is coated on the porous support membrane via the “knife casting” method. The dehydration membrane is then heated to a temperature in a range from about 50 °C to about 160 °C for a period in a range from about 5 minutes to about 60 minutes to remove the solvent.

Example 2: A dehydration membrane is prepared in the configuration of hollow fibers. The dehydration membrane is suitable for dehydrating gases and liquids. The dehydration membrane comprises (a) a porous hollow fiber support membrane with average pore size in a range from about 10 nm to about 0.1 μm and outside diameter ranging from 20 μm to 1 mm; and (b) one selective layer comprising of an ethylene vinyl alcohol copolymer with thickness in a range from about 50 nm to about 10 μm. The selective layer can be either coated on the outside or the inside of the hollow fiber membrane. During the preparation of the casting solution, the ethylene vinyl alcohol copolymer is dissolved in a solvent or a solvent mixture. Then gas bubbles and solid particles are removed from the casting solution with a centrifuge, and the casting solution is coated on the hollow fiber porous support membrane via the “dip casting” method. The dehydration membrane is then heated with hot air to a temperature in a range from about 60 °C to about 160 °C for a period in a range from about 5 minutes to about 60 minutes to remove the solvent.

Example 3: A dehydration membrane is suitable for separating water from gases and liquids. The dehydration membrane comprises (a) a polyester or polypropylene non-woven fabric backing; (b) a polysulfone or polyethersulfone porous support membrane with average pore size in a range from about 10 nm to about 0.1 μm; (c) one selective layer comprising of an ethylene vinyl alcohol copolymer, a cross-linking agent, and a catalyst. The selective layer has a thickness in a range from about 10 nm to about 10 μm. During the preparation of the dehydration membrane, an ethylene vinyl alcohol copolymer is dissolved in a solvent and an aldehyde cross-linking agent and a base catalyst are added to partially cross-link the ethylene vinyl alcohol copolymer. Then gas bubbles and solid particles are removed from the casting solution with a centrifuge, the casting solution is coated on the porous support membrane with “knife casting”. The dehydration membrane is then heated to a temperature in a range from about 60 °C to about 160 °C for a period in a range from about 5 minutes to about 60 minutes to remove the solvent and complete the cross-linking.

Example 4: A dehydration membrane (e.g., a hollow fiber membrane) is suitable for separating water from gases and liquids. The dehydration membrane comprises (a) a polysulfone or polyethersulfone porous hollow fiber support membrane with average pore size in a range from about 10 nm to about 0.1 μm, and (b) one selective layer comprising of an ethylene vinyl alcohol copolymer, a cross-linking agent, and a catalyst. The selective layer has a thickness in a range from about 10 nm to about 10 μm, and can be coated either inside the hollow fiber or outside the hollow fiber. During the preparation of the casting solution, an ethylene vinyl alcohol copolymer is dissolved, then an aldehyde cross-linking agent and a catalyst are added. Then gas bubbles and solid particles are removed from the casting solution with a centrifuge. A hollow fiber is continuously dipped and pulled out from the container with the casting solution so that is the casting solution is coated on the outside of the hollow fiber via the “dip casting” method. Alternatively, the casting solution can be coated on the inside of the hollow fiber by flowing the casting solution through the hollow fiber. The composite hollow fiber membrane is then heated to a temperature in a range from about 60 °C to about 160 °C for a period in a range from about 5 minutes to about 60 minutes to remove the solvent and complete the cross-linking.

Example 5: A dehydration membrane is suitable for separating water from gases and liquids. The dehydration membrane comprises (a) a polyester or polypropylene non-woven fabric backing; (b) a polyethersulfone porous support membrane with average pore size in a range from about 10 nm to about 0.1 μm; (c) one selective layer comprising of an ethylene vinyl alcohol copolymer, polyvinylamine, a cross-linking agent, and a catalyst. The selective layer has a thickness in a range from about 10 nm to about 10 μm. During the preparation of the dehydration membrane, an ethylene vinyl alcohol copolymer and polyvinylamine are dissolved in a solvent and an aldehyde cross-linking agent and a base catalyst are added to partially cross-link the ethylene vinyl alcohol copolymer and the polyvinylamine. Then gas bubbles and solid particles are removed from the casting solution with a centrifuge, the casting solution is coated on the porous support membrane with “knife casting”. The dehydration membrane is then heated to a temperature in a range from about 60 °C to about 160 °C for a period in a range from about 60 minutes to about 180 minutes to remove the solvent and complete the cross-linking.

Example 6: An ethylene vinyl alcohol copolymer is dissolved in a solvent, a base catalyst and chloroacetic acid are added into the ethylene vinyl alcohol copolymer solution. The solution is maintained at about 50 °C to about 80 °C and about 14.7 psia for 1 to 3 hours. Then a base is added to neutralize the solution, and ethanol and water are added to rinse and purify the chemically modified ethylene vinyl alcohol copolymer.

Example 7: A dehydration membrane is suitable for separating water from gases and liquids. The dehydration membrane comprises (a) a polyester or polypropylene non-woven fabric backing; (b) a polyethersulfone porous support membrane with average pore size in a range from about 10 nm to about 0.1 μm; (c) one selective layer comprising of the chemically modified ethylene vinyl alcohol copolymer prepared in Example 6, a cross-linking agent, and a catalyst. The selective layer has a thickness in a range from about 10 nm to about 10 μm. During the preparation of the dehydration membrane, the chemically modified ethylene vinyl alcohol copolymer is dissolved in water and an aldehyde cross-linking agent and a base catalyst are added to the polymer solution. Then gas bubbles and solid particles are removed from the casting solution with a centrifuge, the casting solution is coated on the porous support membrane with “knife casting”. The dehydration membrane is then heated to a temperature in a range from about 60 °C to about 160 °C for a period in a range from about 60 minutes to about 180 minutes to remove the solvent and complete the cross-linking.

Example 8: An ethylene vinyl alcohol copolymer is dissolved in a solvent, a base catalyst and 2,3-epoxypropyltrimethylammonium chloride are added into the ethylene vinyl alcohol copolymer solution. The solution is maintained at about 50 °C to about 80 °C and about 14.7 psia for 2 to 6 hours. Then ethanol is added to rinse and purify the chemically modified ethylene vinyl alcohol copolymer.

Example 9: A dehydration membrane (e.g., a hollow fiber membrane) is suitable for separating water from gases and liquids. The dehydration membrane comprises (a) a polyacrylonitrile porous hollow fiber support membrane with average pore size in a range from about 10 nm to about 0.1 μm, and (b) one selective layer comprising of the chemically modified ethylene vinyl alcohol copolymer prepared from Example 8, a cross-linking agent, and a catalyst. The selective layer has a thickness in a range from about 10 nm to about 10 μm, and can be coated outside the hollow fiber. During the preparation of the casting solution, the chemically modified ethylene vinyl alcohol copolymer from Example 8 is dissolved, then an aldehyde cross-linking agent and a catalyst are added. Then gas bubbles and solid particles are removed from the casting solution with a centrifuge. A hollow fiber is continuously dipped and pulled out from the container filled with the casting solution so that is the casting solution is coated on the outside of the hollow fiber via the “dip casting” method. The composite hollow fiber membrane is then heated to a temperature in a range from about 60 °C to about 160 °C for a period in a range from about 5 minutes to about 60 minutes to remove the solvent and complete the cross-linking.

Example 10: An ethylene vinyl alcohol copolymer is dissolved in a solvent, an 85% phosphoric acid in water solution is added into the ethylene vinyl alcohol copolymer solution. The solution is maintained at about 85 °C to about 99 °C and at about 14.7 psia for a period in a range from about 2 hours to about 6 hours. Then ethanol is used to rinse and purify the chemically modified ethylene vinyl alcohol copolymer.

Example 11: A dehydration membrane is suitable for separating water from gases and liquids. The dehydration membrane comprises (a) a polyester non-woven fabric backing; (b) a polyethersulfone porous support membrane with average pore size in a range from about 10 nm to about 0.1 μm; (c) one selective layer comprising of the chemically modified ethylene vinyl alcohol copolymer prepared in Example 10, a cross-linking agent, and a catalyst. The selective layer has a thickness in a range from about 10 nm to about 10 μm. During the preparation of the dehydration membrane, the chemically modified ethylene vinyl alcohol copolymer is dissolved in water and an aldehyde cross-linking agent and a base catalyst are added to the polymer solution. Then gas bubbles and solid particles are removed from the casting solution with a centrifuge, the casting solution is coated on the porous support membrane with “knife casting”. The dehydration membrane is then heated to a temperature in a range from about 60 °C to about 160 °C for a period in a range from about 60 minutes to about 180 minutes to remove the solvent and complete the cross-linking.

Example 12: An ethylene vinyl alcohol copolymer is dissolved in a solvent, sulfuric acid with 98 percent purity is slowly added into the ethylene vinyl alcohol copolymer solution. The solution is maintained at about 50 °C to about 70 °C and about 14.7 psia for about 10 to 16 hours. Then sodium hydroxide solution is added to adjust pH to 5-10, ethanol and water are added to rinse and purify the chemically modified ethylene vinyl alcohol copolymer.

Example 13: A dehydration membrane is suitable for separating water from gases and liquids. The dehydration membrane comprises (a) a polyester non-woven fabric backing; (b) a polyethersulfone porous support membrane with average pore size in a range from about 10 nm to about 0.1 μm; (c) one selective layer comprising of the chemically modified ethylene vinyl alcohol copolymer prepared in Example 12, a cross-linking agent, and a catalyst. The selective layer has a thickness between 10 nm to 50 μm. During the preparation of the dehydration membrane, the chemically modified ethylene vinyl alcohol copolymer is dissolved in water and an aldehyde cross-linking agent and a base catalyst are added to the polymer solution. Then gas bubbles and solid particles are removed from the casting solution with a centrifuge, the casting solution is coated on the porous support membrane with “knife casting”. The dehydration membrane is then heated to a temperature in a range from about 60 °C to about 160 °C for a period in a range from about 60 minutes to about 180 minutes to remove the solvent and complete the cross-linking.

Example 14: A dehydration membrane is suitable for separating water from gases and liquids. The dehydration membrane comprises (a) a polyester non-woven fabric backing; (b) a polyethersulfone porous support membrane with average pore size in a range from about 10 nm to about 0.1 μm; (c) one selective layer comprising of the chemically modified ethylene vinyl alcohol copolymers prepared in Example 6 and Example 8, a cross-linking agent, and a catalyst. The selective layer has a thickness in a range from about 10 nm to about 10 μm. During the preparation of the dehydration membrane, the chemically modified ethylene vinyl alcohol copolymers are dissolved in water and an aldehyde cross-linking agent and a base catalyst are added to the polymer solution. Then gas bubbles and solid particles are removed from the casting solution with a centrifuge, the casting solution is coated on the porous support membrane with “knife casting”. The dehydration membrane is then heated to a temperature in a range from about 60 °C to about 160 °C for a period in a range from about 60 minutes to about 180 minutes to remove the solvent and complete the cross-linking.

Example 15: A dehydration membrane is suitable for separating water from gases and liquids. The dehydration membrane comprises (a) a polyester non-woven fabric backing; (b) a polyethersulfone porous support membrane with average pore size in a range from about 10 nm to about 0.1 μm; (c) one selective layer comprising of the chemically modified ethylene vinyl alcohol copolymers prepared in Example 8 and Example 10, a cross-linking agent, and a catalyst. The selective layer has a thickness in a range from about 10 nm to about 10 μm. During the preparation of the dehydration membrane, the chemically modified ethylene vinyl alcohol copolymers are dissolved in water and a dialdehyde cross-linking agent and a base catalyst are added to the polymer solution. Then gas bubbles and solid particles are removed from the casting solution with a centrifuge, the casting solution is coated on the porous support membrane with “knife casting”. The dehydration membrane is then heated to a temperature in a range from about 60 °C to about 160 °C for a period in a range from about 60 minutes to about 180 minutes to remove the solvent and complete the cross-linking.

Example 16: A dehydration membrane is suitable for separating water from gases and liquids. The dehydration membrane comprises (a) a polyester non-woven fabric backing; (b) a polyethersulfone porous support membrane with average pore size in a range from about 10 nm to about 0.1 μm; (c) one selective layer comprising of the chemically modified ethylene vinyl alcohol copolymers prepared in Example 8 and Example 12, a cross-linking agent, and a catalyst. The selective layer has a thickness in a range from about 10 nm to about 10 μm. During the preparation of the dehydration membrane, the chemically modified ethylene vinyl alcohol copolymers are dissolved in water and a dialdehyde cross-linking agent and a base catalyst are added to the polymer solution. Then gas bubbles and solid particles are removed from the casting solution with a centrifuge, the casting solution is coated on the porous support membrane with “knife casting”. The dehydration membrane is then heated to a temperature in a range from about 60 °C to about 160 °C for a period in a range from about 60 minutes to about 180 minutes to remove the solvent and complete the cross-linking.

Example 17: A dehydration membrane is suitable for separating water from gases and liquids. The dehydration membrane comprises (a) a polyester or polypropylene non-woven fabric backing; (b) a polyethersulfone porous support membrane with average pore size in a range from about 10 nm to about 0.1 μm; (c) one selective layer comprising of an ethylene vinyl alcohol copolymer, polyvinylamine, a cross-linking agent, a catalyst, zinc nanoparticles, and zinc oxide nanoparticles. The selective layer has a thickness in a range from about 10 nm to about 10 μm. During the preparation of the dehydration membrane, an ethylene vinyl alcohol copolymer and polyvinylamine are dissolved in a solvent. An aldehyde cross-linking agent, a base catalyst, zinc and zinc oxide nanoparticles with diameters ranging from about 30 nm to about 100 nm are added to the polymer solution. Then gas bubbles are removed from the casting solution with a vacuum pump, the casting solution is coated on the porous support membrane with “knife casting”. The dehydration membrane is then heated to a temperature in a range from about 60 °C to about 160 °C for a period in a range from about 60 minutes to about 180 minutes to remove the solvent and complete the cross-linking.

Example 18: A dehydration membrane is suitable for separating water from gases and liquids. The dehydration membrane comprises (a) a polyester non-woven fabric backing; (b) a polyethersulfone porous support membrane with average pore size in a range from about 10 nm to about 0.1 μm; (c) one selective layer comprising of the chemically modified ethylene vinyl alcohol copolymers prepared in Example 8, a cross-linking agent, a catalyst, and surface-treated silver nanoparticles. The selective layer has a thickness in a range from about 10 nm to about 10 μm. During the preparation of the dehydration membrane, the chemically modified ethylene vinyl alcohol copolymer is dissolved in water. An aldehyde cross-linking agent, a base catalyst, and silver nanoparticles with diameters of about 20 nm to about 100 nm are added to the polymer solution. Then gas bubbles are removed from the casting solution with a vacuum pump, the casting solution is coated on the porous support membrane with “knife casting”. The dehydration membrane is then heated to a temperature in a range from about 60 °C to about 160 °C for a period in a range from about 60 minutes to about 180 minutes to remove the solvent and complete the cross-linking.

Example 19: The dehydration membranes prepared from the above examples are used for the separation of water from air (e.g., removing the moisture from the humid air in a heating, ventilation, and air conditioning system). In this separation process, one low-humidity and low-temperature air stream and one high-humidity and high-temperature air stream enter the membrane unit in a heating, ventilation, and air conditioning system. The two air streams are separated by the dehydration membrane, and are flowing in a con-current, a counter-current, or a cross-current flow patterns. Due to the selectivity of the dehydration membrane, water permeates through the membrane from the high-humidity air stream to the low-humidity air stream. Because of the temperature difference between the two air streams, heat is exchanged across the dehydration membrane and the high-humidity and high-temperature air stream is cooled by the low-humidity and low-temperature air stream.

Example 20: The dehydration membranes prepared from Examples 1, 2, 3, 4, 5, 7, 9, 11, 13, 14, 15, 16, 17, and 18 are used for the separation of water from gases such as compressed air, syngas, natural gas, and biogas. In this separation process, the gas that contains water enters a membrane unit on the high-pressure feed side. Due to the selectivity of the dehydration membrane, water permeates through the membrane to the low-pressure permeate side at a higher transport rate than other gas components. As the result, water is removed on the feed side. The low partial pressure of water on the permeate side can be maintained using a vacuum pump or a sweep gas. The permeated water can be condensed and re-used.

Example 21: The dehydration membranes prepared from Examples 1, 2, 3, 4, 5, 7, 9, 11, 13, 14, 15, 16, and 17 are used for the separation of water from liquids such as organic solvents, monomers, chemical intermediates and products, crude oil, and finished fuels. In this separation process, the liquid that contains water enters a membrane unit on the feed side. Due to the selectivity of the dehydration membrane, water permeates through the membrane to the permeate side at a higher transport rate than other liquid components. As the result, water is removed from the liquid on the feed side while the other liquid components are retained on the feed side. The low partial pressure of water on the permeate side is maintained using a vacuum pump or a sweep gas. The permeated water can be condensed and re-used. To increase the water removal rate, the liquid entering the membrane unit is heated to about 40 °C to about 80 °C.

Embodiments of the present disclosure further relate to any one or more of the following Embodiments 1-79:
1. A dehydration membrane, comprising: a non-woven fabric backing; a porous support layer disposed on the non-woven fabric backing; and one or more selective layers disposed on or above the porous support layer, wherein each of the selective layers independently comprises a selective polymeric material, wherein at least one of the selective layers comprises an ethylene vinyl alcohol polymeric material as the selective polymeric material.
2. A dehydration membrane, comprising: a non-woven fabric backing; a porous support layer disposed on the non-woven fabric backing; a first selective layer disposed on the porous support layer and comprising a first selective polymeric material; and a second selective layer disposed on the first selective layer, wherein the second selective layer comprises a second selective polymeric material, wherein the first selective polymeric material, the second selective polymeric material, or both the first and second selective polymeric materials comprises an ethylene vinyl alcohol polymeric material.
3. A dehydration membrane, comprising: a porous support layer; and one or more selective layers disposed on or above the porous support layer, wherein each of the selective layers independently comprises a selective polymeric material, wherein at least one of the selective layers comprises an ethylene vinyl alcohol polymeric material as the selective polymeric material.
4. A dehydration membrane, comprising: a porous support layer; a first selective layer disposed on the porous support layer and comprising a first selective polymeric material; and a second selective layer disposed on the first selective layer, wherein the second selective layer comprises a second selective polymeric material, wherein the first selective polymeric material, the second selective polymeric material, or both the first and second selective polymeric materials comprises an ethylene vinyl alcohol polymeric material.
5. The dehydration membrane according to any one of Embodiments 1-4, wherein the dehydration membrane has a thickness in a range from about 60 μm to about 2 mm.
6. The dehydration membrane according to any one of Embodiments 1-4, wherein the dehydration membrane is configured as a flat sheet membrane, a spiral-wound membrane, a hollow fiber membrane, or a plate-and-frame membrane.
7. The dehydration membrane according to Embodiment 1 or 2, wherein the dehydration membrane is a flat sheet membrane.
8. The dehydration membrane according to Embodiment 3 or 4, wherein the dehydration membrane is a hollow fiber membrane.
9. The dehydration membrane according to any one of Embodiments 1-4, wherein the one or more selective layers and/or the first selective layer is configured to separate water from a fluid mixture comprising a base fluid and water.
10. The dehydration membrane according to Embodiment 9, wherein the base fluid comprises a gas component, a liquid component, or a combination thereof.
11. The dehydration membrane according to Embodiment 9, wherein the base fluid comprises a fluid selected from the group consisting of air, natural gas, flue gas, syngas, biogas, refinery off-gases, nitrogen (N₂), oxygen (O₂), argon, helium, and any combination thereof.
12. The dehydration membrane according to Embodiment 9, wherein the base fluid comprises a fluid selected from the group consisting of crude oil, fuel, organic solvent, a hydrocarbon gas, a hydrocarbon liquid, a product stream in a chemical or petrochemical facility, and any combination thereof.
13. The dehydration membrane according to any one of Embodiments 1-4, wherein the one or more selective layers and/or the first selective layer is configured to separate water from air entering or within a heating system, a ventilation system, or an air conditioning system.
14. The dehydration membrane according to any one of Embodiments 1-2, wherein the non-woven fabric backing has a thickness in a range from about 50 μm to about 1 mm.
15. The dehydration membrane according to any one of Embodiments 1-2, wherein the non-woven fabric backing comprises a plurality of fibers, and wherein the fibers comprises a material selected from the group consisting of polyethylene terephthalate, polyester, polypropylene, polyethylene, polyamide, polyimide, fiberglass, cellulose, regenerated cellulose, wood pulp, cotton, wool, carbon, and any combination thereof.
16. The dehydration membrane according to any one of Embodiments 1-4, wherein the porous support layer has a thickness in a range from about 10 μm to about 500 μm.
17. The dehydration membrane according to any one of Embodiments 1-4, wherein the porous support layer comprises a plurality of pores having an average pore size in a range from about 1 nm to about 0.1 μm.
18. The dehydration membrane according to any one of Embodiments 1-4, wherein the porous support layer comprises a porous polymeric material selected from the group consisting of a polyamide, a polyimide, a polyester, a sulfone-based polymer, a polymeric organosilicone, a fluorinated polymer, a polyacrylonitrile, a polybenzimidazole, a cellulose-based polymer, oligomers thereof, complexes thereof, derivatives thereof, and any combination thereof.
19. The dehydration membrane according to Embodiment 18, wherein the porous polymeric material is selected from the group consisting of polysulfone, polyphenylsulfone, polyethersulfone, polydimethylsiloxane, polytetrafluoroethylene, polyvinylidene fluoride, cellulose acetate, oligomers thereof, complexes thereof, derivatives thereof, and any combination thereof.
20. The dehydration membrane according to any one of Embodiments 1-4, wherein the dehydration membrane comprises a plurality of selective layers disposed on or over the porous support layer, and wherein the plurality of selective layers comprises from 2 selective layers to about 200 selective layers.
21. The dehydration membrane according to Embodiment 20, wherein each of the selective layers comprises a different composition than the composition of an adjacent or neighboring selective layer, and/or wherein the first selective layer comprises a different composition than the composition of second selective layer.
22. The dehydration membrane according to any one of Embodiments 1-4, wherein each of the one or more selective layers, the first selective layer, and the second selective layer independently has a thickness in a range from about 1 nm to about 100 μm.
23. The dehydration membrane according to any one of Embodiments 1-4, wherein each of the one or more of the selective layers, the first selective layer, and the second selective layer independently comprises an ethylene vinyl alcohol copolymer.
24. The dehydration membrane according to any one of Embodiments 1-4, wherein the ethylene vinyl alcohol polymeric material comprises an ethylene vinyl alcohol copolymer which has an ethylene to vinyl alcohol molar ratio in a range from about 1:19 to about 19:1.
25. The dehydration membrane according to any one of Embodiments 1-4, wherein the ethylene vinyl alcohol polymeric material comprises an ethylene vinyl alcohol copolymer which has an ethylene to vinyl alcohol molar ratio in a range from about 1:4 to about 4:1.
26. The dehydration membrane according to any one of Embodiments 1-4, wherein the ethylene vinyl alcohol polymeric material has an ethylene content in a range from about 5 mole percent to about 95 mole percent.
27. The dehydration membrane according to any one of Embodiments 1-4, wherein the ethylene vinyl alcohol polymeric material has an ethylene content in a range from about 20 mole percent to about 80 mole percent.
28. The dehydration membrane according to any one of Embodiments 1-4, wherein the ethylene vinyl alcohol polymeric material has a weight average molecular weight of greater than 600 Daltons and less than 5,000,000 Daltons.
29. The dehydration membrane according to any one of Embodiments 1-4, wherein the ethylene vinyl alcohol polymeric material has at least one of the chemical formulas represented by Formulas (1), (2a), (2b), (3a), (3b), (4a), (4b), (5a), (5b), (6a), and (6b):

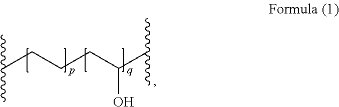

wherein each of p and q of Formula (1) is independently an integer in a range from 1 to about 32,000, such as in a range from about 100 to about 32,000;

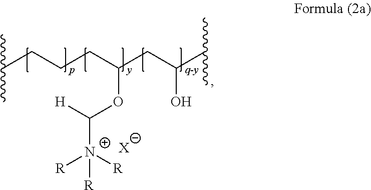

each of p and q of Formula (2a) is independently an integer in a range from 1 to about 32,000, such as in a range from about 100 to about 32,000, each y of Formula (2a) is an integer in a range from 1 to about 6,400, each R of Formula (2a) is independently an alkyl group with chemical formula of CₙH₂ₙ₊₁, wherein n is an integer in a range from 0 to about 18, and X of Formula (2a) is fluoride, chloride, bromide, or iodide;

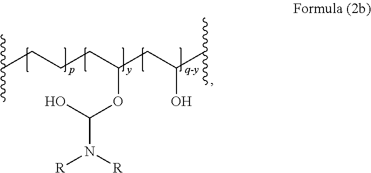

wherein each of p and q of Formula (2b) is independently an integer in a range from 1 to about 32,000, such as in a range from about 100 to about 32,000, each y of Formula (2b) is an integer in a range from 1 to about 6,400, each R of Formula (2b) is independently an alkyl group with chemical formula of CₙH₂ₙ₊₁, wherein n is an integer in a range from 0 to about 18;

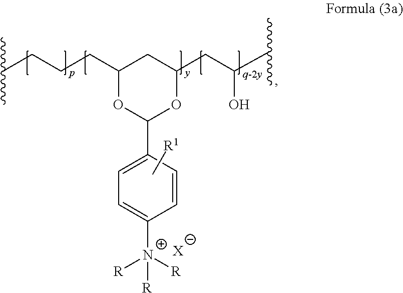

wherein each of p and q of Formula (3a) is independently an integer in a range from 1 to about 32,000, such as in a range from about 100 to about 32,000, each y of Formula (3a) is an integer in a range from 1 to about 6,400, each R of Formula (3a) is independently an alkyl group with chemical formula of CₙH₂ₙ₊₁, wherein n is an integer in a range from 0 to about 18, and R¹ of Formula (3a) is an alkyl group with formula CₙH₂ₙ₊₁ and n is an integer in a range from 0 to about 18, or an alkyl hydroxyl group with formula CₙH₂ₙOH and n is an integer in a range from 0 to about 18; and X of Formula (3a) is fluoride, chloride, bromide, or iodide;

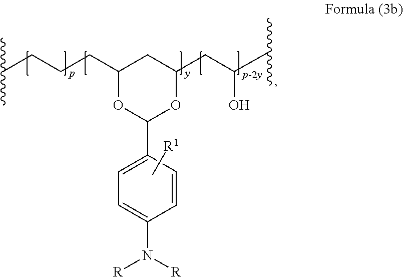

wherein each of p Formula (3b) is independently an integer in a range from 1 to about 32,000, such as in a range from about 100 to about 32,000, each y of Formula (3b) is an integer in a range from 1 to about 6,400, each R of Formula (3b) is independently an alkyl group with chemical formula of CₙH₂ₙ₊₁, wherein n is an integer in a range from 0 to about 18, and R¹ of Formula (3b) is an alkyl group with formula CₙH₂ₙ₊₁ and n is an integer in a range from 0 to about 18, or an alkyl hydroxyl group with formula CₙH₂ₙOH and n is an integer in a range from 0 to about 18;

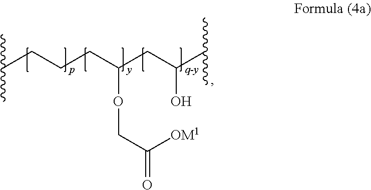

wherein each of p and q of Formula (4a) is independently an integer in a range from 1 to about 32,000, such as in a range from about 100 to about 32,000, each y of Formula (4a) is an integer in a range from 1 to about 6,400, and M¹ of Formula (4a) is hydrogen, lithium, sodium, potassium, cesium, or any combination thereof;

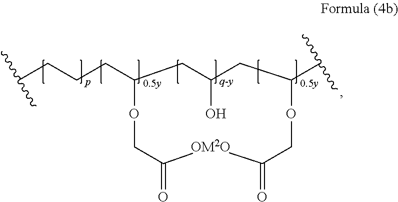

wherein each of p and q of Formula (4b) is independently an integer in a range from 1 to about 32,000, such as in a range from about 100 to about 32,000, each y of Formula (4b) is an integer in a range from 1 to about 6,400, and M² of Formula (4b) is magnesium, calcium, or any combination thereof;

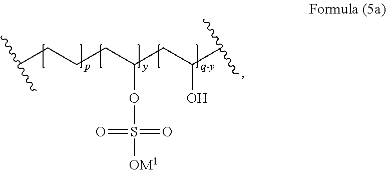

and wherein each of p and q of Formula (5a) is independently an integer in a range from 1 to about 32,000, such as in a range from about 100 to about 32,000, each y of Formula (5a) is an integer in a range from 1 to about 6,400, and M¹ of Formula (5a) is hydrogen, lithium, sodium, potassium, cesium, or any combination thereof;

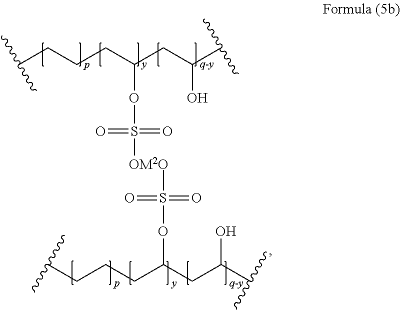

and wherein each of p and q of Formula (5b) is independently an integer in a range from 1 to about 32,000, such as in a range from about 100 to about 32,000, each y of Formula (5b) is an integer in a range from 1 to about 6,400, and M² of Formula (5b) is magnesium, calcium, or any combination thereof;

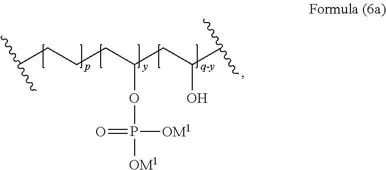

wherein each of p and q of Formula (6a) is independently an integer in a range from 1 to about 32,000, such as in a range from about 100 to about 32,000, each y of Formula (6a) is an integer in a range from 1 to about 6,400, and M¹ of Formula (6a) is hydrogen, lithium, sodium, potassium, cesium, or any combination thereof;

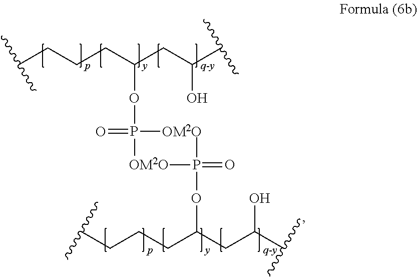

wherein each of p and q of Formula (6b) is independently an integer in a range from 1 to about 32,000, such as in a range from about 100 to about 32,000, each y of Formula (6b) is an integer in a range from 1 to about 6,400, and M² of Formula (6b) is magnesium, calcium, or any combination thereof.
30. The dehydration membrane according to any one of Embodiments 1-4, wherein the ethylene vinyl alcohol polymeric material has at least one of the chemical formulas represented by Formulas (7), (8), (9), (10), and (11):

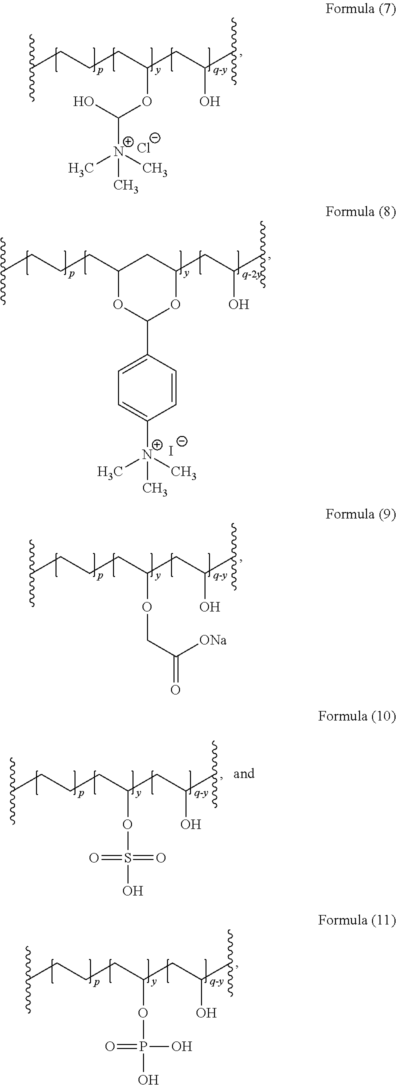

wherein each of p and q of Formulas (7), (8), (9), (10), and (11) is independently an integer in a range from 1 to about 32,000, such as in a range from about 100 to about 32,000, and wherein each y of Formulas (7), (8), (9), (10), and (11) is independently an integer in a range from 1 to about 6,400.
31. The dehydration membrane according to any one of Embodiments 29-30, wherein the ethylene vinyl alcohol polymeric material has a molar ratio of ethylene and vinyl alcohol of about 1 to19 to about 19 to 1.
32. The dehydration membrane according to any one of Embodiments 29-30, wherein the ethylene vinyl alcohol polymeric material has a molar ratio of ethylene and vinyl alcohol of about 1 to 4 and about 4 to 1.
33. The dehydration membrane according to any one of Embodiments 29-30, wherein the ethylene vinyl alcohol polymeric material has an ethylene content in a range from about 5 mole percent (mol %) to about 95 mol %.
34. The dehydration membrane according to any one of Embodiments 29-30, wherein the ethylene vinyl alcohol polymeric material has an ethylene content in a range from about 20 mol % to about 80 mol %.
35. The dehydration membrane according to any one of Embodiments 29-30, wherein the ethylene vinyl alcohol polymeric material has a weight average molecular weight in a range from about 600 Daltons to about 5,000,000 Daltons.
36. The dehydration membrane according to any one of Embodiments 29-30, wherein the ethylene vinyl alcohol polymeric material has a molar ratio of p and q in a range from about 1 to 19 to about 19 to 1.
37. The dehydration membrane according to any one of Embodiments 29-30, wherein the ethylene vinyl alcohol polymeric material has a molar ratio of p and q in a range from about 1 to 4 to about 4 to 1.
38. The dehydration membrane according to any one of Embodiments 29-30, wherein the ethylene vinyl alcohol polymeric material has a molar ratio of y and q in a range from about 1 to 200 to about 199 to 200.
39. The dehydration membrane according to any one of Embodiments 29-30, wherein the ethylene vinyl alcohol polymeric material has a molar ratio of y and q in a range from about 1 to 100 to about 1 to 5.
40. The dehydration membrane according to any one of Embodiments 29-30, wherein the ethylene vinyl alcohol polymeric material has a weight average molecular weight in a range from about 600 Daltons to about 5,000,000 Daltons.
41. The dehydration membrane according to any one of Embodiments 1-40, wherein the ethylene vinyl alcohol polymeric material further comprises a polyelectrolyte having repeating units containing one or more one ionic or ionizable groups.
42. The dehydration membrane according to any one of Embodiments 1-41, wherein the ethylene vinyl alcohol polymeric material further comprises a polyelectrolyte, and wherein the polyelectrolyte comprises a material selected from the group consisting of a polymethyleneamine, a reaction product from a polymethyleneamine and an acid, a polyvinylamine, a reaction product from a polyvinylamine and an acid, a polyallylamine, a reaction product from a polyallylamine and an acid, a polyethylenimine, a reaction product from a polyethylenimine and an acid, a branched polyethylenimine, a reaction product from a branched polyethylenimine and an acid, a poly(diallyldimethylammonium chloride), a poly(4-styrenesulfonic acid), a reaction product from a poly(4-styrenesulfonic acid) and a base, a poly(vinyl sulfonic acid), a reaction product from a poly(vinyl sulfonic acid) and a base, a poly(acrylic acid), a reaction product from a poly(acrylic acid) and a base, and any combination thereof.
43. The dehydration membrane according to Embodiment 42, wherein the acid is selected from the group consisting of hydrochloric acid, sulfuric acid, phosphoric acid, nitric acid, acetic acid, boric acid, hydrofluoric acid, hydrobromic acid, hydroiodic acid, oxalic acid, citric acid, p-toluenesulfonic acid, carbonic acid, salts thereof, derivatives thereof, and any combination thereof.
44. The dehydration membrane according to Embodiment 42, wherein the base is selected from the group consisting of lithium hydroxide, sodium hydroxide, potassium hydroxide, rubidium hydroxide, cesium hydroxide, magnesium hydroxide, calcium hydroxide, strontium hydroxide, barium hydroxide, lithium carbonate, lithium bicarbonate, sodium carbonate, sodium bicarbonate, potassium carbonate, potassium bicarbonate, rubidium carbonate, rubidium bicarbonate, cesium carbonate, cesium bicarbonate, salts thereof, and any combination thereof.
45. The dehydration membrane according to any one of Embodiments 1-4, wherein the ethylene vinyl alcohol polymeric material further comprises a material selected from the group consisting of a polyelectrolyte, and wherein the polyelectrolyte comprises a poly(allylamine hydrochloride), a linear polyethylenimine, a poly(sodium 4-styrenesulfonate), a poly(vinyl sulfate) sodium salt, and any combination thereof.
46. The dehydration membrane according to any one of Embodiments 1-4, wherein the ethylene vinyl alcohol polymeric material further comprises a polyelectrolyte, and wherein the polyelectrolyte has at least one of the chemical formulas represented by Formulas (16), (17), (18), (19a), (19b), (20), (21), (22), or (23):

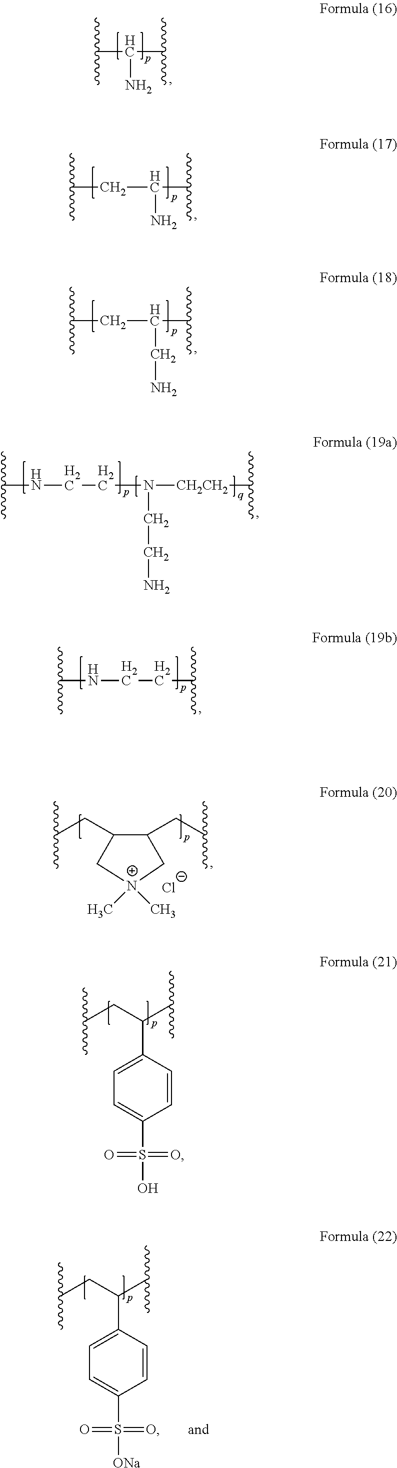

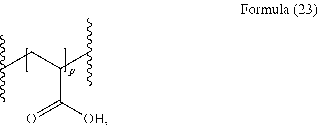

wherein each of p and q, where applicable, of Formulas (16), (17), (18), (19a), (19b), (20), (21), (22), or (23) is independently an integer in a range from 1 to about 32,000, such as from about 100 to about 32,000.
47. The dehydration membrane according to any one of Embodiments 41-46, wherein the polyelectrolyte has a weight average molecular weight in a range from about 600 to about 5,000,000.
48. The dehydration membrane according to any one of Embodiments 1-4, wherein the ethylene vinyl alcohol polymeric material comprises one or more polyelectrolytes with a positive charge and one or more polyelectrolytes with a negative charge.
49. The dehydration membrane according to Embodiment 48, wherein the polyelectrolytes have a weight ratio of the polyelectrolytes with the positive charge relative to the polyelectrolytes with the negative charge in a range from about 1 to 49 to about 49 to 200.
49. The dehydration membrane according to Embodiment 48, wherein the polyelectrolytes have a weight ratio of the polyelectrolytes with the positive charge relative to the polyelectrolytes with the negative charge in a range from about 1 to 5 to about 5 to 1.
50. The dehydration membrane according to any one of Embodiments 1-4, wherein the ethylene vinyl alcohol polymeric material is a reaction product prepared from a functional or cross-linking group, wherein the functional or cross-linking group is selected from the group consisting of an aldehyde, a dialdehyde, a diepoxide, and any combination thereof.
51. The dehydration membrane according to Embodiment 50, wherein the functional or cross-linking group contains the aldehyde, wherein the aldehyde is represented by the formula H(O)CR, wherein R has at least one of the chemical formulas represented by Formulas (12a)-(12i):

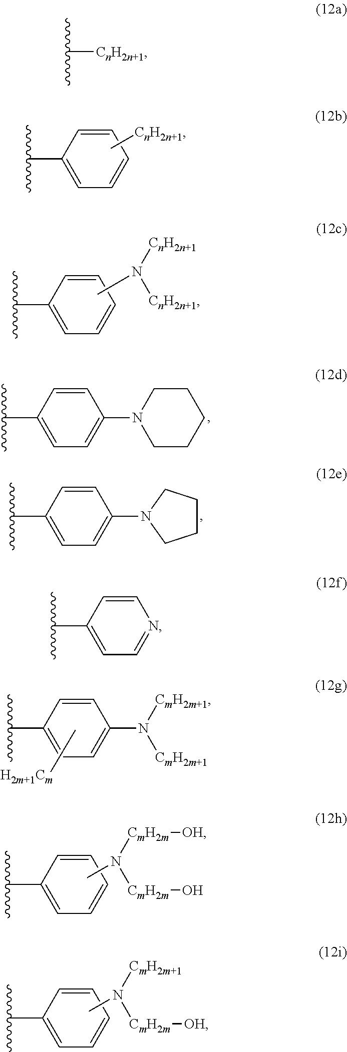

or any combination thereof, and wherein n of Formulas (12a)-(12c) is an integer in a range from 0 to about 18, and m of Formulas (12g)-(12i) is an integer in a range from 1 to about 18.
52. The dehydration membrane according to Embodiment 50, wherein the functional or cross-linking group contains the dialdehyde, and wherein the dialdehyde is represented by the formula H(O)CRC(O)H, wherein R has at least one of the chemical formulas represented by Formulas (13a)-(13b):

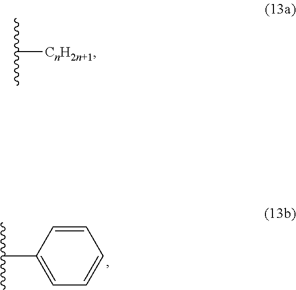

or any combination thereof, and wherein n of Formula (13a) is an integer in a range from 0 to about 18.
53. The dehydration membrane according to Embodiment 50, wherein the functional or cross-linking group contains the diepoxide, and the diepoxide has the chemical formulas represented by Formulas (14)-(15):

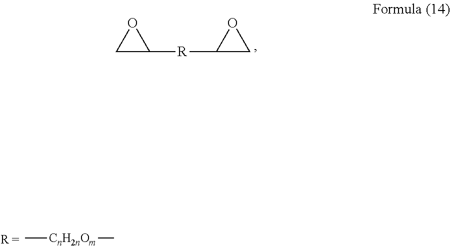

wherein R of Formula (14) is the alkyl group, n of Formula (14) is an integer in a range from 0 to about 18, and m of Formula (14) is an integer in a range from 0 to 4, and/or

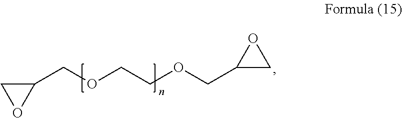

wherein n of Formula (15) is an integer in a range from 1 and about 1,000.
54. The dehydration membrane according to any one of Embodiments 1-53, wherein each of the one or more selective layers, the first selective layer, and the second selective layer independently comprises a catalyst, and wherein the catalyst comprises an acid or a base.
55. The dehydration membrane according to Embodiment 54, wherein the catalyst comprises an acid, and wherein the acid is selected from the group consisting of hydrochloric acid, sulfuric acid, phosphoric acid, nitric acid, acetic acid, boric acid, hydrofluoric acid, oxalic acid, citric acid, carbonic acid, p-toluenesulfonic acid, salts thereof, complexes thereof, and any combination thereof.
56. The dehydration membrane according to Embodiment 54, wherein the catalyst comprises a base, and wherein the base is selected from the group consisting of lithium hydroxide, sodium hydroxide, potassium hydroxide, rubidium hydroxide, cesium hydroxide, magnesium hydroxide, calcium hydroxide, strontium hydroxide, barium hydroxide, lithium carbonate, lithium bicarbonate, sodium carbonate, sodium bicarbonate, potassium carbonate, potassium bicarbonate, rubidium carbonate, rubidium bicarbonate, cesium carbonate, cesium bicarbonate, lithium methoxide, lithium ethylate, sodium methoxide, sodium ethylate, potassium methoxide, potassium ethylate, magnesium methoxide, magnesium ethylate, calcium methoxide, calcium ethylate, salts thereof, complexes thereof, and any combination thereof.
57. The dehydration membrane according to any one of Embodiments 55-56, wherein each of the one or more selective layers, the first selective layer, and the second selective layer independently comprises the cross-linking agent and the catalyst, and wherein the cross-linking agent and the catalyst are at a weight ratio in a range from about 1:100,000 to about 1:1.
58. The dehydration membrane according to any one of Embodiments 55-56, wherein each of the one or more selective layers, the first selective layer, and the second selective layer independently comprises the cross-linking agent and the catalyst, and wherein the cross-linking agent and the catalyst are at a weight ratio in a range from about 1:9,999 to about 1:1.
59. The dehydration membrane according to any one of Embodiments 1-58, wherein each of the one or more selective layers, the first selective layer, and the second selective layer independently further comprises metal nanoparticles.
60. The dehydration membrane according to Embodiment 59, wherein the metal nanoparticles are selected from the group consisting of zinc nanoparticles, zinc oxide nanoparticles, copper nanoparticles, copper oxide nanoparticles, titanium nanoparticles, titanium oxide nanoparticles, silver nanoparticles, gold nanoparticles, and any combination thereof.
61. The dehydration membrane according to Embodiment 59, wherein the metal nanoparticles comprise a surface-treatment coating disposed on an outer surface of each of the metal nanoparticles, and wherein the surface-treatment coating comprises a material selected from the group consisting of an organo-functional silane, a hydrophilic polymer, a hydrophilic monomer, or any combination thereof.
62. The dehydration membrane according to any one of Embodiments 59-61, wherein the selective layer has a weight ratio of the metal nanoparticles to the ethylene vinyl alcohol polymeric material in a range from about 1 to 5,000 to about 1 to 4.
63. The dehydration membrane according to any one of Embodiments 59-61, wherein the selective layer has a weight ratio of the metal nanoparticles to the ethylene vinyl alcohol polymeric material in a range from about 1 to 1,000 and about 1 to 19.
64. A method for preparing each of the one or more selective layers, the first selective layer, and/or the second selective layer according to any one of Embodiments 1-63, comprising: combining an ethylene vinyl alcohol copolymer, an optional polyelectrolyte, an optional cross-linking agent, an optional catalyst, optional metal nanoparticles, and a solvent to produce a selective layer material mixture; coating the selective layer material mixture to the porous support layer; and drying the selective layer material mixture to produce the selective layer disposed on the porous support layer.
65. The method according to Embodiment 64, wherein the selective layer material mixture is maintained at a temperature in a range from about 1 °C to about 120 °C at a pressure in a range from about 14.7 psia (pound per square inch absolute pressure) to about 500 psia for about 1 minute to about 24 hours while producing the selective layer disposed on the porous support layer.
66. The method according to Embodiment 64, wherein the selective layer material mixture is coated to the porous support layer by a coating technique comprising knife casting, dip casting, or spray coating.
67. The method according to Embodiment 64, wherein drying comprises drying the selective layer material mixture at a temperature in a range from about 1 °C to about 199 °C for about 1 minute to about 24 hours.
68. The method according to Embodiment 64, wherein the solvent is selected from the group consisting of water, methanol, ethanol, isopropyl alcohol, propyl alcohol, dichloromethane, tetrahydrofuran, ethyl acetate, acetonitrile, dimethylformamide, dimethyl sulfoxide, dimethylacetamide, 1-methyl-2-pyrrolidinoneacetone, hexamethylphosphoric triamide, ethylene glycol, diethylene glycol, ethylene carbonate, propylene carbonate, pyridine, and any combination thereof.
69. A method for separating water from a fluid, comprising: introducing a fluid mixture comprising water and a base fluid to a feed side of the dehydration membrane according to any one of Embodiments 1-68, wherein the separation membrane contains the feed side opposite of a permeate side; removing the water from the feed side while retaining the base fluid on the feed side; and recovering the water from the permeate side.
70. The method according to Embodiment 69, wherein the base fluid is in a liquid state, a gas state, or a combination thereof.
71. The method according to Embodiment 69, wherein the water is in a liquid state, a gas state, or a combination thereof.
72. The method according to Embodiment 69, wherein the fluid mixture comprises air, natural gas, flue gas, syngas, biogas, a refinery gas, or any combination thereof.
73. The method according to Embodiment 69, wherein the base fluid comprises a material selected from the group consisting of methane, ethane, ethene, propylene, other hydrocarbon gases, nitrogen (N₂), argon, carbon dioxide, carbon monoxide, hydrogen sulfide, ammonia, and any combination thereof.
74. The method according to Embodiment 69, wherein the fluid mixture comprises a material selected from the group consisting of crude oil, fuel, organic solvent, a hydrocarbon gas, a hydrocarbon liquid, a product stream in a chemical or petrochemical facility, and any combination thereof.
75. The method according to Embodiment 69, wherein the feed side is maintained at a first pressure equal to or greater than a second pressure of the permeate side.
76. The method according to Embodiment 75, wherein the first pressure is in a range from about 14.7 psia to about 1,000 psia and the second pressure is in a range from about 0.00001 psia to about 50 psia.
77. The method according to Embodiment 69, wherein the fluid mixture is at a temperature in a range from about 40 °C to about 120 °C when introduced into the feed side.
78. A method for separating water from air, comprising: introducing a humid air to a feed side of the dehydration membrane according to any one of Embodiments 1-68, wherein the separation membrane contains the feed side opposite of a permeate side; removing water from the feed side while retaining a dehumidified air on the feed side; and recovering the water from the permeate side.
79. The method according to Embodiment 78, further comprises introducing the dehumidified air into a heating system, a ventilation system, or an air conditioning system.

While the foregoing is directed to embodiments of the disclosure, other and further embodiments may be devised without departing from the basic scope thereof, and the scope thereof is determined by the claims that follow. All documents described herein are incorporated by reference herein, including any priority documents and/or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise, the term “comprising” is considered synonymous with the term “including” for purposes of United States law. Likewise, whenever a composition, an element, or a group of elements is preceded with the transitional phrase “comprising”, it is understood that the same composition or group of elements with transitional phrases “consisting essentially of”, “consisting of”, “selected from the group of consisting of”, or “is” preceding the recitation of the composition, element, or elements and vice versa, are contemplated. As used herein, the term “about” refers to a +/−10% variation from the nominal value. It is to be understood that such a variation can be included in any value provided herein.

Certain embodiments and features have been described using a set of numerical upper limits and a set of numerical lower limits. It should be appreciated that any stated range of numerical values includes the lower endpoint value and the upper endpoint value, unless otherwise indicated. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below.

1-80. (canceled)

81. A dehydration membrane, comprising:
a non-woven fabric backing;
a porous support layer disposed on the non-woven fabric backing; and
one or more selective layers disposed on or above the porous support layer, wherein each of the selective layers independently comprises a selective polymeric material, wherein at least one of the selective layers comprises an ethylene vinyl alcohol polymeric material as the selective polymeric material.

82. The dehydration membrane of claim 81, wherein the dehydration membrane is configured as a flat sheet membrane.

83. The dehydration membrane of claim 81, wherein the dehydration membrane is configured as a hollow fiber membrane.

84. The dehydration membrane of claim 81, wherein the dehydration membrane is configured as a spiral-wound membrane or a plate-and-frame membrane.

85. The dehydration membrane of claim 81, wherein each of the one or more selective layers is independently configured to separate water from a fluid mixture comprising a base fluid and the water.

86. The dehydration membrane of claim 85, wherein the base fluid comprises a fluid selected from the group consisting of air, natural gas, flue gas, syngas, biogas, refinery off-gases, nitrogen (N₂), oxygen (O₂), argon, helium, and any combination thereof.

87. The dehydration membrane of claim 85, wherein the base fluid comprises a fluid selected from the group consisting of crude oil, fuel, organic solvent, a hydrocarbon gas, a hydrocarbon liquid, a product stream in a chemical or petrochemical facility, and any combination thereof.

88. The dehydration membrane of claim 81, wherein each of the one or more selective layers is configured to separate water from air entering or within a heating system, a ventilation system, or an air conditioning system.

89. The dehydration membrane of claim 81, wherein each of the one or more selective layers independently has a thickness in a range from about 1 nm to about 100 μm.

90. The dehydration membrane of claim 81, wherein each of the one or more of the selective layers independently comprises an ethylene vinyl alcohol copolymer.

91. The dehydration membrane of claim 81, wherein the ethylene vinyl alcohol polymeric material has an ethylene content in a range from about 5 mole percent to about 95 mole percent.

92. The dehydration membrane of claim 81, wherein the ethylene vinyl alcohol polymeric material has a weight average molecular weight of greater than 600 Daltons and less than 5,000,000 Daltons.

93. The dehydration membrane of claim 81, wherein the ethylene vinyl alcohol polymeric material has at least one of the chemical formulas represented by Formulas (1), (2a), (2b), (3a), (3b), (4a), (4b), (5a), (5b), (6a), or (6b): 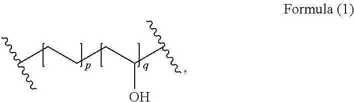
wherein each of p and q of Formula (1) is independently an integer in a range from 1 to about 32,000; 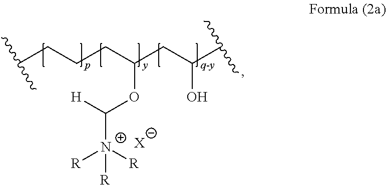
wherein each of p and q of Formula (2a) is independently an integer in a range from 1 to about 32,000, and y of Formula (2a) is an integer in a range from 1 to about 6,400, each R of Formula (2a) is independently an alkyl group, and X of Formula (2a) is fluoride, chloride, bromide, or iodide; 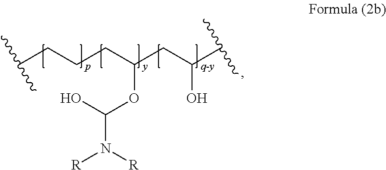
wherein each of p and q of Formula (2b) is independently an integer in a range from 1 to about 32,000, each y of Formula (2b) is independently an integer in a range from 1 to about 6,400, and each R of Formula (2b) is independently an alkyl group; 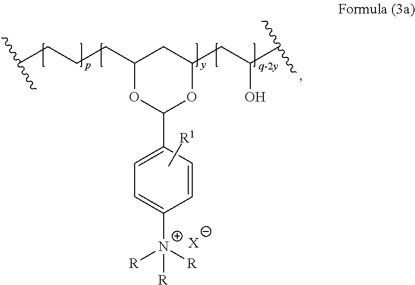
wherein each of p and q of Formula (3a) is independently an integer in a range from 1 to about 32,000, each y of Formula (3a) is independently an integer in a range from 1 to about 6,400, each R of Formula (3a) is independently an alkyl group, and R¹ of Formula (3a) is an alkyl group, or an alkyl hydroxyl group; and X of Formula (3a) is fluoride, chloride, bromide, or iodide; 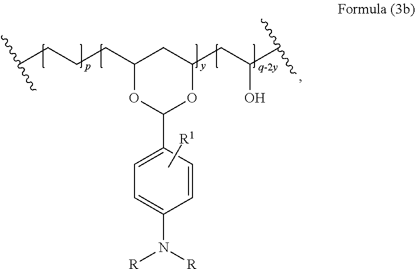
wherein each p of Formula (3b) is independently an integer in a range from 100 to about 32,000, each y of Formula (3b) is independently an integer in a range from 1 to about 6,400, each R of Formula (3b) is independently an alkyl group, and R¹ of Formula (3b) is an alkyl group, or an alkyl hydroxyl group; 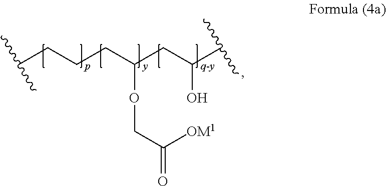
wherein each of p and q of Formula (4a) is independently an integer in a range from 1 to about 32,000, each y of Formula (4a) is independently an integer in a range from 1 to about 6,400, and M¹ of Formula (4a) is hydrogen, lithium, sodium, potassium, cesium, or any combination thereof; 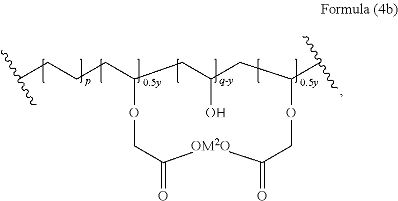
wherein each of p and q of Formula (4b) is independently an integer in a range from 1 to about 32,000, each y of Formula (4b) is independently an integer in a range from 1 to about 6,400, and M² of Formula (4b) is magnesium, calcium, or any combination thereof; 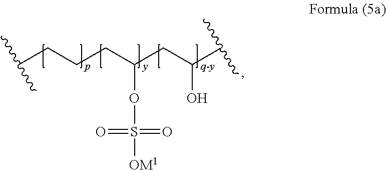
and
wherein each of p and q of Formula (5a) is independently an integer in a range from 1 to about 32,000, each y of Formula (5a) is independently an integer in a range from 1 to about 6,400, and M¹ of Formula (5a) is hydrogen, lithium, sodium, potassium, cesium, or any combination thereof; 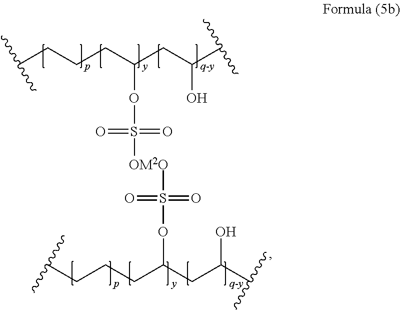
and
wherein each of p and q of Formula (5b) is independently an integer in a range from 1 to about 32,000, each y of Formula (5b) is independently an integer in a range from 1 to about 6,400, and M² of Formula (5b) is magnesium, calcium, or any combination thereof; 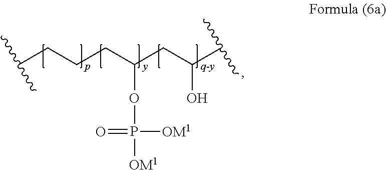
wherein each of p and q of Formula (6a) is independently an integer in a range from 1 to about 32,000, each y of Formula (6a) is independently an integer in a range from 1 to about 6,400, and M¹ of Formula (6a) is hydrogen, lithium, sodium, potassium, cesium, or any combination thereof; and 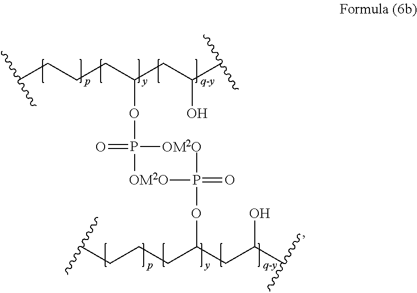
wherein each of p and q of Formula (6b) is independently an integer in a range from 1 to about 32,000, each y of Formula (6b) is independently an integer in a range from 1 to about 6,400, and M² of Formula (6b) is magnesium, calcium, or any combination thereof.

94. The dehydration membrane of claim 81, wherein the ethylene vinyl alcohol polymeric material further comprises a polyelectrolyte having repeating units containing one or more one ionic or ionizable groups.

95. The dehydration membrane of claim 81, wherein the ethylene vinyl alcohol polymeric material further comprises a polyelectrolyte, and wherein the polyelectrolyte comprises a material selected from the group consisting of a polymethyleneamine, a reaction product from a polymethyleneamine and an acid, a polyvinylamine, a reaction product from a polyvinylamine and the acid, a polyallylamine, a reaction product from a polyallylamine and the acid, a polyethylenimine, a reaction product from a polyethylenimine and the acid, a branched polyethylenimine, a reaction product from a branched polyethylenimine and the acid, a poly(diallyldimethylammonium chloride), a poly(4-styrenesulfonic acid), a reaction product from a poly(4-styrenesulfonic acid) and a base, a poly(vinyl sulfonic acid), a reaction product from a poly(vinyl sulfonic acid) and the base, a poly(acrylic acid), a reaction product from a poly(acrylic acid) and the base, and any combination thereof.

96. The dehydration membrane of claim 95, wherein the polyelectrolyte has a weight average molecular weight in a range from about 600 to about 5,000,000.

97. The dehydration membrane of claim 95, wherein the acid is selected from the group consisting of hydrochloric acid, sulfuric acid, phosphoric acid, nitric acid, acetic acid, boric acid, hydrofluoric acid, hydrobromic acid, hydroiodic acid, oxalic acid, citric acid, p-toluenesulfonic acid, carbonic acid, salts thereof, derivatives thereof, and any combination thereof.

98. The dehydration membrane of claim 95, wherein the base is selected from the group consisting of lithium hydroxide, sodium hydroxide, potassium hydroxide, rubidium hydroxide, cesium hydroxide, magnesium hydroxide, calcium hydroxide, strontium hydroxide, barium hydroxide, lithium carbonate, lithium bicarbonate, sodium carbonate, sodium bicarbonate, potassium carbonate, potassium bicarbonate, rubidium carbonate, rubidium bicarbonate, cesium carbonate, cesium bicarbonate, salts thereof, and any combination thereof.

99. The dehydration membrane of claim 81, wherein the ethylene vinyl alcohol polymeric material is a reaction product prepared from a functional or cross-linking group, and wherein the functional or cross-linking group is selected from the group consisting of an aldehyde, a dialdehyde, a diepoxide, and any combination thereof.

100. The dehydration membrane of claim 81, wherein each of the one or more selective layers independently further comprises metal nanoparticles.

101. The dehydration membrane of claim 100, wherein the metal nanoparticles are selected from the group consisting of zinc nanoparticles, zinc oxide nanoparticles, copper nanoparticles, copper oxide nanoparticles, titanium nanoparticles, titanium oxide nanoparticles, silver nanoparticles, gold nanoparticles, and any combination thereof.

102. A method for separating water from a fluid, comprising:
introducing a fluid mixture comprising water and a base fluid to a feed side of a dehydration membrane, wherein the dehydration membrane contains the feed side opposite of a permeate side, and wherein the dehydration membrane comprises:
a non-woven fabric backing;
a porous support layer disposed on the non-woven fabric backing; and
one or more selective layers disposed on or above the porous support layer, wherein each of the selective layers independently comprises a selective polymeric material, wherein at least one of the selective layers comprises an ethylene vinyl alcohol polymeric material as the selective polymeric material;
removing the water from the feed side while retaining the base fluid on the feed side; and
recovering the water from the permeate side.
